(19) United States
(12) Patent Application Publication
(10) Pub. No.: US 2024/0352276 A1
(43) Pub. Date: Oct. 24, 2024

(54) PROCESS OF MAKING ARTICLES COMPRISING POLYESTER/POLYESTER ELASTOMER COMPOSITIONS

(71) Applicant: Eastman Chemical Company, Kingsport, TN (US)

(72) Inventors: Marc Alan Strand, Kingsport, TN (US); Robert Erik Young, Kingsport, TN (US)

(73) Assignee: Eastman Chemical Company, Kingsport, TN (US)

(21) Appl. No.: 18/569,243

(22) PCT Filed: Jun. 16, 2022
(86) PCT No.: PCT/US2022/033738

§ 371 Date: Dec. 12, 2023

Related U.S. Application Data
(60) Provisional application No. 63/202,604, filed on Jun. 17, 2021.

(51) Int. Cl. C09D 167/02; C08K 5/13; C08K 5/524; C09D 5/03; C09D 7/63

(52) U.S. Cl. CPC C09D 167/025; C08K 5/13; C08K 5/524; C09D 5/03; C09D 7/63; C08K 2201/012

(57) ABSTRACT

A process of making a polyester coated article is provided. The process comprises coating an article with a polyester composition to produce the polyester coated article; wherein the polyester composition comprises a) at least one rigid polyester; b) at least one polyester elastomer; c) at least one primary antioxidant; d) at least one secondary antioxidant; and e) at least one chain extending additive; wherein the composition has a enthalpy of melting of 3 cal/gm or less.

### FIELD OF THE INVENTION

The invention generally relates to a polyester composition comprising at least one rigid polyester and at least one polyester elastomer, at least one primary antioxidant, at least one secondary antioxidant, and at least one chain extending agent as well as articles produced from the polyester composition.

Processes to produce the polyester compositions as well as processes to produce articles comprising the polyester compositions are also provided.

### BACKGROUND OF THE INVENTION

Useful compositions comprising rigid polyesters and copolyester elastomer with improved thermal stability and improved physical and processing properties are disclosed. Thermoplastic polyesters are typically considered rigid thermoplastics with high tensile strength and modulus values. Thermoplastic polyester elastomers are typically considered inherently flexible materials with lower tensile strength and modulus values. In certain applications, it is useful to have materials with physical properties in between rigid polyesters and elastomeric polyesters. It is also useful in certain applications and processing techniques such as powder coating to have improved color, processing and thermal stability properties. We have discovered that a range of rigid polyester and polyester elastomer compositions which incorporate thermal stabilizers create useful materials that have improved initial color, improved thermal stability and physical properties.

### SUMMARY OF THE INVENTION

In one embodiment of the invention, a polyester composition is provided comprising: a) at least one rigid polyester; b) at least one polyester elastomer; c) at least one primary antioxidant; d) at least one secondary antioxidant; and e) at least one chain extending additive; wherein the polyester composition has a enthalpy of melting of 3 cal/gm or less.

In another embodiment of the invention, a process to produce a polyester composition is provided comprising contacting a) at least one rigid polyester; b) at least one polyester elastomer; c) at least one primary antioxidant; d) at least one secondary antioxidant; and e) at least one chain extending additive to produce a polyester composition; wherein the polyester composition has a enthalpy of melting of 3 cal/gm or less.

In another embodiment of the invention, a process to produce a polyester composition is provided comprising extruding a) at least one rigid polyester; b) at least one polyester elastomer; c) at least one primary antioxidant; d) at least one secondary antioxidant; and e) at least one chain extending additive in an extrusion zone to produce a polyester composition; wherein the polyester composition has a enthalpy of melting of 3 cal/gm or less.

In another embodiment of the invention, a process to produce a polyester composition is provided comprising: a) polymerizing at least one dicarboxylic acid and at least one diol to produce a rigid polyester having a Tg greater than 60° C.; b) polymerizing at least one dicarboxylic acid, at least one diol, and at least one polyol to produce a polyester elastomer having a Tg less than 50° C.; and c) contacting the rigid polyester with the polyester elastomer and at least one chain extending additive to produce the polyester composition; wherein the polyester composition has a enthalpy of melting of 3 cal/gm or less; wherein the polymerizing in steps a) and/or b) is conducted in the presence of at least one primary antioxidant; and wherein the polymerizing in steps 1) and/or 2) is conducted in the presence of at least one secondary antioxidant.

In another embodiment of the invention, a process to produce a polyester composition is provided comprising a) polymerizing at least one dicarboxylic acid and at least one diol in the presence of 1) at least one primary antioxidant; and 2) at least one secondary antioxidant to produce a rigid polyester having a Tg greater than 60° C.; b) polymerizing at least one dicarboxylic acid, at least one diol, and at least one polyol to produce a polyester elastomer having a Tg less than 0° C., and c) contacting the rigid polyester with the polyester elastomer and at least one chain extending additive to produce the polyester composition; wherein the polyester composition has a enthalpy of melting of 3 cal/gm or less.

In another embodiment of the invention, a process to produce a polyester composition, the process comprising a) polymerizing at least one dicarboxylic acid and at least one diol to produce a rigid polyester having a Tg greater than 60° C.; b) polymerizing at least one dicarboxylic acid, at least one diol, and at least one polyol in the presence of 1) at least one primary antioxidant; and 2) at least one secondary antioxidant to produce a polyester elastomer having a Tg less than 0° C., and c) contacting the rigid polyester with the polyester elastomer and at least one chain extending additive to produce the polyester composition; wherein the polyester composition has a enthalpy of melting of 3 cal/gm or less.

In another embodiment of the invention, an article is provided comprising a polyester composition; wherein the polyester composition comprises a) at least one rigid polyester; b) at least one polyester elastomer; c) at least one primary antioxidant; d) at least one secondary antioxidant; and e) at least one chain extending additive; wherein the composition has a enthalpy of melting of 3 cal/gm or less.

In another embodiment of the invention, a process is provided for making a polyester coated article comprising coating an article with a polyester composition to produce the polyester coated article; wherein the wherein the polyester composition comprises a) at least one rigid polyester; b) at least one polyester elastomer; c) at least one primary antioxidant; d) at least one secondary antioxidant; and e) at least one chain extending additive; wherein the composition has a enthalpy of melting of 3 cal/gm or less.

In yet another embodiment of the invention, a process of manufacturing a molded article is provided comprising:
a) placing a polyester composition in a mold having mold surfaces; wherein the polyester composition comprises: 1) at least one rigid polyester; 2) at least one polyester elastomer; 3) at least one primary antioxidant; 4) at least one secondary antioxidant; and 5) at least one chain extending additive; wherein the composition has a enthalpy of melting of 3 cal/gm or less;
b) heating the polyester composition until it becomes molten;
c) dispersing the molten polyester composition to cover the mold surfaces;
d) solidifying the molten polyester to form a solid molded article; and
e) removing the molded article from the mold.

### DETAILED DESCRIPTION

The present invention may be understood more readily by reference to the following detailed description of certain embodiments of the invention and the working examples. In accordance with the purpose(s) of this invention, certain embodiments of the invention are described in the Summary of the Invention and are further described herein below. Also, other embodiments of the invention are described herein.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, each numerical parameter should at least be construed in light of the number of reported significant digits and by applying ordinary rounding techniques. Further, the ranges stated in this disclosure and the claims are intended to include the entire range specifically and not just the endpoint(s). For example, a range stated to be 0 to 10 is intended to disclose all whole numbers between 0 and 10 such as, for example 1, 2, 3, 4, etc., all fractional numbers between 0 and 10, for example 1.5, 2.3, 4.57, 6.1113, etc., and the endpoints 0 and 10. Also, a range associated with chemical substituent groups such as, for example, “C₁ to C₅ hydrocarbons,” is intended to specifically include and disclose C₁ and C₅ hydrocarbons as well as C₂, C₃, and C₄ hydrocarbons.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

As used in the specification and the claims, the singular forms “a,” “an” and “the” include their plural references unless the context clearly dictates otherwise. References to a composition or process containing or including “an” ingredient or “a” step is intended to include other ingredients or other steps, respectively, in addition to the one named.

The terms “containing” or “including,” are synonymous with the term “comprising,” and is intended to mean that at least the named compound, element, particle, or method step, etc., is present in the composition or article or method, but does not exclude the presence of other compounds, catalysts, materials, particles, method steps, etc., even if the other such compounds, material, particles, method steps, etc., have the same function as what is named, unless expressly excluded in the claims.

The term “polyester”, as used herein, is synonymous with the term “resin” and is intended to mean a polymer prepared by the polycondensation of one or more specific diacid components, diol components, and optionally polyol components.

The term “residue”, as used herein in reference to the polymers of the invention, means any organic structure incorporated into a polymer through a polycondensation or ring opening reaction involving the corresponding monomer. It will also be understood by persons having ordinary skill in the art, that the residues associated within the various polyesters of the invention can be derived from the parent monomer compound itself or any derivative of the parent compound. For example, the dicarboxylic acid residues referred to in the polymers of the invention may be derived from a dicarboxylic acid monomer or its associated acid halides, esters, salts, anhydrides, or mixtures thereof. Thus, as used herein, the term “dicarboxylic acid” is intended to include dicarboxylic acids and any derivative of a dicarboxylic acid, including its associated acid halides, esters, half-esters, salts, half-salts, anhydrides, mixed anhydrides, or mixtures thereof, useful in a polycondensation process with a diol to make a curable, aliphatic polyester.

The term “branching agent” refers to an alcohol or an acid molecule with three or more functional groups. Examples of alcohol branching agents include glycerine, trimethylol propane and pentaerythritol. Trimellitic anhydride is an example of an acid based branching agent.

The term “polyol” used in this application refers to a polymeric diol such as polytetramethylene ether glycol (PTMG), polyethylene glycol, polypropylene glycol and the like. In some embodiments of this invention the polyols have an absolute molecular weight of from about 600 g/mol to about 5000 g/mol.

It is also to be understood that the mention of one or more method steps does not preclude the presence of additional method steps before or after the combined recited steps or intervening method steps between those steps expressly identified. Moreover, the lettering of process steps or ingredients is a convenient means for identifying discrete activities or ingredients and the recited lettering can be arranged in any sequence, unless otherwise indicated.

The present invention involves a polyester composition comprising: a) at least one rigid polyester; b) at least one polyester elastomer; c) at least one primary antioxidant; d) at least one secondary antioxidant; and e) at least one chain extending additive; wherein said composition has a enthalpy of melting of 3 cal/gm or less.

In other embodiments of the invention, the enthalpy of melting of the polyester composition is less than 3, less than 2.7, less than 2.5, less than 2.3, less than 2, less than 1.7, less than 1.5, less than 1.3, and less than 1 cal/gm. In other embodiments, the enthalpy of melting of the polyester composition ranges from 0.1 to 3 cal/gm, 0.3 to 3 cal/gm, 0.5 to 3 cal/gm, 0.7 to 3 cal/gm, 1 to 3 cal/gm, 1.2 to 3 cal/gm, 1.5 to 3 cal/gm, 2 to 3 cal/gm, 0.1 to 2.5 cal/gm, 0.3 to 2.5 cal/gm, 0.5 to 2.5 cal/gm, 0.7 to 2.5 cal/gm, 1 to 2.5 cal/gm, 1.5 to 2.5 cal/gm, 2 to 2.5 cal/gm, 0.1 to 2 cal/gm, 0.3 to 2 cal/gm, 0.5 to 2 cal/gm, 0.7 to 2 cal/gm, 1 to 2 cal/gm, 1.2 to 2 cal/gm, 1.5 to 2 cal/gm, 0.1 to 1.5 cal/gm, 0.3 to 1.5 cal/gm, 0.5 to 1.5 cal/gm, 0.7 to 1.5 cal/gm, 1 to 1.5 cal/gm, 0.1 to 1 cal/gm, 0.3 to 1 cal/gm, 0.5 to 1 cal/gm, 0.1 to 0.7 cal/gm, 0.3 to 0.7 cal/gm, 0.1 to 0.5 cal/gm as measured by ASTM D3418.

In an embodiment of the invention, the polyester composition exhibits a blister size of 6 or greater as determined by ASTM D714 after 500 hours of Salt Fog testing per ASTM B117.

In another embodiment, the polyester composition exhibits a scribe rust value of 6 or greater as determined by ASTM D1654.

In another embodiment of the invention, the polyester composition has an impact resistance of 160 ft-lbs or greater as measured by ASTM D2794 when applied to metal panels. Other ranges for impact resistance is 170 ft-lbs or greater, 180 ft-lbs or greater, 190 ft-lbs or greater, or 200 ft-lbs or greater as measured by ASTM D2794.

### Rigid Polyesters

Rigid polyesters can be any known in the art having a Glass Transition Temperature (Tg) of greater than 60° C. Other rigid polyesters useful in this invention have a Tg of greater than 65° C., greater than 70° C., greater than 75° C., greater than 80° C., greater than 85° C., greater than 90° C., greater than 100° C., greater than 105° C., greater than 110° C., greater than 115° C., greater than 120° C., or greater than 125° C.

In other aspects of the invention, the Tg of the rigid polyesters or copolyesters useful in the invention can be, but is not limited to, at least one of the following ranges: 50 to 150° C.; 50 to 145° C., 50 to 140° C., 50 to 135° C., 50 to 130° C., 50 to 125° C., 50 to 120° C., 55 to 150° C.; 55 to 145° C., 55 to 140° C., 55 to 135° C., 55 to 130° C., 55 to 125° C., 55 to 120° C., 60 to 150° C.; 60 to 145° C., 60 to 140° C., 60 to 135° C., 60 to 130° C., 60 to 125° C., 60 to 120° C., 65 to 150° C.; 60 to 145° C., 60 to 140° C., 60 to 135° C., 60 to 130° C., 60 to 125° C., 60 to 120° C., 65 to 150° C., 65 to 145° C., 65 to 140° C., 65 to 135° C., 65 to 130° C., 65 to 125° C., 65 to 120° C., 70 to 150° C.; 70 to 145° C., 70 to 140° C., 70 to 135° C., 70 to 130° C., 70 to 125° C., 70 to 120° C., 75 to 150° C.; 75 to 145° C., 75 to 140° C., 75 to 135° C., 75 to 130° C., 75 to 125° C., 75 to 120° C., as measured by ASTM Method 3418.

The flexural modulus of the rigid polyester is greater than 1,000 Mpa measured by ASTM D790. In another embodiment, the flexural modulus of the rigid polyester is greater than 1,100, greater than 1,200, greater than 1,300, greater than 1,400, and greater 1,500 measured by ASTM D790. In other embodiments of the invention, the flexural modulus of the rigid polyester ranges from about 1,000 to about 2,600 Mpa, about 1,000 to about 2,500 Mpa, about 1,000 to about 2,000 Mpa, about 1,000 to about 1,500 Mpa, about 1,000 to about 1,400 MPa, about 1,000 to about 1,300 Mpa, 1,100 to about 2,600 Mpa, about 1,100 to about 2,500 Mpa, about 1,100 to about 2,000 Mpa, about 1,100 to about 1,500 Mpa, about 1,100 to about 1,400 MPa, about 1,100 to about 1,300 Mpa, about 1,200 to about 2,600 Mpa, about 1,200 to about 2,500 Mpa, about 1,200 to about 2,000 Mpa, about 1,200 to about 1,500 Mpa, about 1,200 to about 1,400 MPa, about 1,200 to about 1,300 Mpa, 1,300 to about 2,600 Mpa, about 1,300 to about 2,500 Mpa, about 1,300 to about 2,000 Mpa, and about 1,300 to about 1,500 Mpa,

The rigid polyesters useful in the present invention can comprise residues of at least one diacid and residues of at least one glycol. The term “copolyester,” as used herein, is intended to include “polyesters” and is understood to mean a synthetic polymer prepared by the reaction of one or more difunctional carboxylic acids and/or multifunctional carboxylic acids with one or more difunctional hydroxyl compounds and/or multifunctional hydroxyl compounds. Typically, the difunctional carboxylic acid can be a dicarboxylic acid and the difunctional hydroxyl compound can be a dihydric alcohol such as, for example, glycols. Furthermore, as used in this application, the interchangeable terms “diacid” or “dicarboxylic acid” include multifunctional acids, such as branching agents. The term “glycol” as used in this application includes, but is not limited to, diols, glycols, and/or multifunctional hydroxyl compounds. Alternatively, the difunctional carboxylic acid may be a hydroxy carboxylic acid such as, for example, p-hydroxybenzoic acid, and the difunctional hydroxyl compound may be an aromatic nucleus bearing 2 hydroxyl substituents such as, for example, hydroquinone.

The term “residue,” as used herein, means any organic structure incorporated into a polymer through a polycondensation and/or an esterification reaction from the corresponding monomer.

The term “repeating unit,” as used herein, means an organic structure having a dicarboxylic acid residue and a diol residue bonded through an ester group. Thus, for example, the dicarboxylic acid residues may be derived from a dicarboxylic acid monomer or its associated acid halides, esters, half-esters, salts, half-salts, anhydrides, mixed anhydrides, or mixtures thereof, useful in a reaction process with a diol to make polyester.

As used herein, the term “terephthalic acid” is intended to include terephthalic acid itself and residues thereof as well as any derivative of terephthalic acid, including its associated acid halides, esters, half-esters, salts, half-salts, anhydrides, mixed anhydrides, or mixtures thereof or residues thereof useful in a reaction process with a diol to make polyester. The term “modifying aromatic diacid” means an aromatic dicarboxylic acid other the terephthalic acid. The term “modifying glycol” means a glycol other than 1,4-cyclohexanedimethanol. In one embodiment, terephthalic acid may be used as the starting material. In another embodiment, dimethyl terephthalate may be used as the starting material. In another embodiment, mixtures of terephthalic acid and dimethyl terephthalate may be used as the starting material and/or as an intermediate material.

The polyesters and copolyesters of the present invention are readily prepared by methods well known in the art, for example, as described in U.S. Pat. No. 2,012,267, incorporated herein by reference in its entirety. More particularly, the reactions for preparing the copolyesters are usually carried out at temperatures of about 150° C. to about 300° C. in the presence of polycondensation catalysts such as titanium tetrachloride, manganese diacetate, antimony oxide, dibutyl tin diacetate, zinc chloride, germanium or combinations thereof. The catalysts are typically employed in amounts of 10 to 1000 ppm, based on total weight of the reactants.

In one embodiment, the rigid polyester comprises dicarboxylic acid residues and diol residues; wherein the dicarboxylic residues are at least one selected from terepthalic acid and isothalic acid; and wherein the diol residues are at least one selected from ethylene glycol and diethylene glycol.

In another embodiment, the rigid polyester comprises cyclohexanedimethanol residues, e.g. 1,4-cyclohexanedimethanol. In another embodiment, the rigid polyester useful in the invention can contain ethylene glycol residues.

Condensation polymers are also susceptible to hydrolytic degradation if not pre-dried or if they are held at elevated temperatures in moist air for a long period of time. Condensation polymers are any polymers where monomers reacting during polycondensation to create a polymer and a by-product such as water or methanol is produced. The polymerization reaction is reversible; thus, condensation polymers are often pre-dried before processing.

The rigid polyesters used in the present invention typically can be prepared from dicarboxylic acids and diols which react in substantially equal proportions and are incorporated into the rigid polyester polymer as their corresponding residues. The rigid polyesters of the present invention, therefore, can contain substantially equal molar proportions of acid residues (100 mole %) and diol (and/or multifunctional hydroxyl compounds) residues (100 mole %) such that the total moles of repeating units is equal to 100 mole %. The mole percentages provided in the present disclosure, therefore, may be based on the total moles of acid residues, the total moles of diol residues, or the total moles of repeating units. For example, a polyester containing 70 mole % terephthalic acid, based on the total acid residues, means the polyester contains 70 mole % terephthalic acid residues out of a total of 100 mole % acid residues. Thus, there are 70 moles of terephthalic acid residues among every 100 moles of acid residues. In another example, a polyester containing 30 mole % 1,4-cyclohexanedimethanol residues, based on the total diol residues, means the polyester contains 30 mole % 1,4-cyclohexanedimethanol residues out of a total of 100 mole % diol residues. Thus, there are 30 moles of 1,4-cyclohexanedimethanol residues among every 100 moles of diol residues.

In one embodiment, the rigid polyester or copolyesters comprise compositions with a single diacid or combinations of diacids such as terephthalic acid or phthalic acid or other diacids with 8 to 20 carbon atoms, with combinations of modifying glycols such as cyclohexanedimethanol or ethylene glycol or other glycols with 2 to 20 carbon atoms.

In certain embodiments, the rigid polyester comprises at least one diol residue. In certain embodiments, the rigid polyester comprises at least one dicarboxylic acid or an ester thereof and at least one diol, wherein the total of acid residues present is 100 mole % and wherein the total of diol residues is 100 mole %. In certain embodiments, the rigid polyester comprises 1,4-cyclohexanedimethanol residues.

In certain embodiments, terephthalic acid, or an ester thereof, such as, for example, dimethyl terephthalate, or a mixture of terephthalic acid and an ester thereof, makes up most or all of the dicarboxylic acid component used to form the rigid polyesters useful in the invention. In certain embodiments, terephthalic acid residues can make up a portion or all of the dicarboxylic acid component used to form the rigid polyester at a concentration of at least 70 mole %, such as at least 80 mole %, at least 90 mole %, at least 95 mole %, at least 99 mole %, or 100 mole %. In certain embodiments, rigid polyesters with high amounts of terephthalic acid can be used in order to produce higher impact strength properties. For purposes of this disclosure, the terms “terephthalic acid” and “dimethyl terephthalate” are used interchangeably herein. In one embodiment, dimethyl terephthalate is part or all of the dicarboxylic acid component used to make the polyesters useful in the present invention. In all embodiments, ranges of from 70 to 100 mole %; or 80 to 100 mole %; or 90 to 100 mole %; or 99 to 100 mole %; or 100 mole % terephthalic acid and/or dimethyl terephthalate and/or mixtures thereof may be used.

In addition to terephthalic acids and/or dimethyl terephthalate residues, the dicarboxylic acid component of the rigid polyesters useful in the invention can comprise up to 50 mole %, up to 40 mole %, up to 30 mole %, up to 20 mole %, up to 10 mole %, up to 5 mole %, or up to 1 mole % of one or more modifying aromatic dicarboxylic acids. Yet another embodiment contains 0 mole % modifying aromatic dicarboxylic acids. Thus, if present, it is contemplated that the amount of one or more modifying aromatic dicarboxylic acids can range from any of these preceding endpoint values including, for example, from 0.01 to 30 mole %, from 0.01 to 20 mole %, from 0.01 to 10 mole %, from 0.01 to 5 mole %, or from 0.01 to 1 mole % of one or more modifying aromatic dicarboxylic acids. In one embodiment, modifying aromatic dicarboxylic acids that may be used in the present invention include, but are not limited to, those having up to 20 carbon atoms. Examples of modifying aromatic dicarboxylic acids which may be used in this invention include, but are not limited to, isophthalic acid, 4,4-biphenyldicarboxylic acid, 1,4-, 1,5-, 2,6-, 2,7-naphthalenedicarboxylic acid, and trans-4,4-stilbenedicarboxylic acid, and esters thereof. In one embodiment, isophthalic acid is the modifying aromatic dicarboxylic acid. In one embodiment, dimethyl isophthalate is used. In one embodiment, dimethyl naphthalate is used.

The carboxylic acid component of the rigid polyesters useful in the invention can be further modified with up to 10 mole %, such as up to 5 mole % or up to 1 mole % of one or more aliphatic dicarboxylic acids containing 2-16 carbon atoms, such as, for example, malonic, succinic, glutaric, adipic, pimelic, suberic, azelaic and dodecanedioic dicarboxylic acids or their corresponding esters including, but not limited, to dimethyl adipate, dimethyl glutarate and dimethyl succinate. Certain embodiments can also comprise 0.01 or more mole %, such as 0.1 or more mole %, 1 or more mole %, 5 or more mole %, or 10 or more mole % of one or more modifying aliphatic dicarboxylic acids. Yet another embodiment contains 0 mole % modifying aliphatic dicarboxylic acids. Thus, if present, it is contemplated that the amount of one or more modifying aliphatic dicarboxylic acids can range from any of these preceding endpoint values including, for example, from 0.01 to 10 mole % and from 0.1 to 10 mole %. The total mole % of the dicarboxylic acid component is 100 mole %.

In one embodiment, only esters of terephthalic acid and esters of the other modifying dicarboxylic acids may be used instead of the dicarboxylic acids. Suitable examples of dicarboxylic acid esters include, but are not limited to, the dimethyl, diethyl, dipropyl, diisopropyl, dibutyl, and diphenyl esters. In one embodiment, the esters are chosen from at least one of the following: methyl, ethyl, propyl, and phenyl esters.

In one embodiment of the invention, the rigid polyesters useful in the invention can contain less than 30 mole % of one or more modifying glycols. In another embodiment, the polyesters useful in the invention can contain 20 mole % or less of one or more modifying glycols. In another embodiment, the rigid polyesters useful in the invention can contain 10 mole % or less of one or more modifying glycols. In another embodiment, the polyesters useful in the invention can contain 5 mole % or less of one or more modifying glycols. In another embodiment, the rigid polyesters useful in the invention may contain 0 mole % modifying glycols. Certain embodiments can also contain 0.01 or more mole %, such as 0.1 or more mole %, 1 or more mole % of one or more modifying glycols. Thus, if present, it is contemplated that the amount of one or more modifying glycols can range from any of these preceding endpoint values including, for example, from 0.01 to 15 mole % and from 0.1 to 10 mole %.

Modifying glycols useful in the rigid polyesters useful in the invention can contain 2 to 16 carbon atoms. For TMCD-CHDM rigid polyesters (polymers comprising 2,2,4,4-tetramethyl-1,3-cyclobutanediol, 1,4-cyclohexanedimethanol, and terephthalic acid residues), a modifying glycol can be residues of ethylene glycol. Examples of other suitable modifying glycols useful in the polyesters described herein include, but are not limited glycols selected from ethylene glycol, diethylene glycol, triethylene glycol, isosorbide, propane-1,3-diol, butane-1,4-diol, 2,2-dimethylpropane-1,3-diol (neopentyl glycol), 2,2,4,4-tetramethyl-1,3-cyclobutanediol, pentane-1,5-diol, hexane-1,6-diol, 1,4-cyclohexanedimethanol, 3-methyl-pentanediol-(2,4), 2-methylpentanediol-(1,4), 2,2,4-tri-methylpentane-diol-(1,3), 2-ethylhexanediol-(1,3), 2,2-diethylpropane-diol-(1,3), hexanediol-(1,3), 1,4-di-(hydroxyethoxy)-benzene, 2,2-bis-(4-hydroxycyclohexyl)-propane, 2,4-dihydroxy-1,1,3,3-tetramethyl-cyclobutane, 2,2-bis-(3-hydroxyethoxyphenyl)-propane, 2,2-bis-(4-hydroxypropoxyphenyl)-propane, and mixtures thereof.

In one TMCD rigid polyester embodiment, ethylene glycol is excluded as a modifying diol. For modified PETG and modified PCTG polymers, the modifying glycol can be a glycol other than ethylene glycol and 1,4-cyclohexanedimethanol, for example.

The rigid polyesters useful in the polyester compositions of the invention can comprise from 0 to 10 mole % of at least one branching agent, for example, 0.01 to 5 mole % or 0.01 to 4 mole % or from 0.01 to 3 mole % or from 0.01 to 2 mole % or from 0.01 to about 1.5 mole % or from 0.01 to 1 mole % or from 0.1 to 5 mole % or 0.1 to 4 mole % or from 0.1 to 3 mole % or from 0.1 to 2 mole % or from 0.1 to about 1.5 mole % or from 0.1 to 1 mole or from 0.5 to 5 mole % or 0.5 to 4 mole % or from 0.5 to 3 mole % or from 0.5 to 2 mole % or from 0.5 to about 1.5 mole % or from 0.5 to 1 mole % or from 1 to 5 mole % or 1 to 4 mole % or from 1 to 3 mole % or from 1 to 2 mole % or from 0.1 to 0.7 mole %, or 0.1 to 0.5 mole %, based the total mole percentages of either the diol or diacid residues, based on at total of 100 mole % diols and 100 mole % diacids; respectively, of one or more residues of a branching monomer, also referred to herein as a branching agent, having 3 or more carboxyl substituents, hydroxyl substituents, or a combination thereof. In certain embodiments, the branching monomer or agent may be added prior to and/or during and/or after the polymerization of the rigid polyester. The rigid polyester(s) useful in the invention can thus be linear or branched.

Examples of branching monomers include, but are not limited to, multifunctional acids or multifunctional alcohols such as trimellitic acid, trimellitic anhydride, pyromellitic dianhydride, trimethylolpropane, trimethylolethane, glycerol, pentaerythritol, citric acid, tartaric acid, 3-hydroxyglutaric acid, pentaerythritol, sorbitol, 1,2,6-hexanetriol, glycerine tetra-maleaic anhydride, and trimesic acid, and the like or mixtures thereof.

In one embodiment, at least one of trimellitic acid, trimellitic anhydride, trimesic acid, pentaerythritol, glycerine, tetra-maleaic anhydride, and trimer acid can be used as the branching agent. The branching monomer may be added to the rigid polyester reaction mixture or blended with the rigid polyester in the form of a concentrate as described, for example, in U.S. Pat. Nos. 5,654,347 and 5,696,176.

The rigid polyesters useful in the invention can comprise residues of 1,4-cyclohexanedimethanol in any amount, included but not limited to at least one of the following amounts: from 0.01 to 100 mole %; from 0.01 to 100 mole %; from 0.01 to 99.99 mole %; from 0.10 to 99 mole %; from 0.10 to 99 mole %; from 0.10 to 95 mole %; from 0.10 to 90 mole %; from 0.10 to 85 mole %; from 0.10 to 80 mole %; from 0.10 to 70 mole %; from 0.10 to 60 mole %; from 0.10 to 50 mole %; from 0.10 to 40 mole %; from 0.10 to 35 mole %; from 0.10 to 30 mole %; from 0.10 to 25 mole %; from 0.10 to 20 mole %; from 0.10 to 15 mole %; from 0.10 to 10 mole %; from 0.10 to 5 mole %; from 1 to 100 mole %; from 1 to 99 mole %; 1 to 95 mole %; from 1 to 90 mole %; from 1 to 85 mole %; from 1 to 80 mole %; from 1 to 70 mole %; from 1 to 60 mole %; from 1 to 50 mole %; from 1 to 40 mole %; from 1 to 35 mole %; from 1 to 30 mole %; from 1 to 25 mole %; from 1 to 20 mole %; from 1 to 15 mole %; from 1 to 10 mole %; from 1 to 5 mole %; 5 to 100 mole %; 5 to 99 mole %; 5 to 95 mole %; from 5 to 90 mole %; from 5 to 85 mole %; from 5 to 80 mole %; 5 to 70 mole %; from 5 to 60 mole %; from 5 to 50 mole %; from 5 to 40 mole %; from 5 to 35 mole %; from 5 to 30 mole %; from 5 to 25 mole %; from 5 to 20 mole %; and from 5 to 15 mole %; from 5 to 10 mole %; from 10 to 100 mole %; from 10 to 99 mole %; 10 to 95 mole %; from 10 to 90 mole %; from 10 to 85 mole %; from 10 to 80 mole %; from 10 to 70 mole %; from 10 to 60 mole %; from 10 to 50 mole %; from 10 to 40 mole %; from 10 to 35 mole %; from 10 to 30 mole %; from 10 to 25 mole %; from 10 to 20 mole %; from 10 to 15 mole %; from 20 to 100 mole %; from 20 to 99 mole %; 20 to 95 mole %; from 20 to 90 mole %; from 20 to 85 mole %; from 20 to 80 mole %; from 20 to 70 mole %; from 20 to 60 mole %; from 20 to 50 mole %; from 20 to 40 mole %; from 20 to 35 mole %; from 20 to 30 mole %; and from 20 to 25 mole %; 30 to 100 mole %; from 30 to 99 mole %; 30 to 95 mole %; from 30 to 90 mole %; from 30 to 85 mole %; from 30 to 80 mole %; from 30 to 70 mole %; from 30 to 60 mole %; from 30 to 50 mole %; from 30 to 40 mole %; from 30 to 35 mole %; 40 to 100 mole %; from 40 to 99 mole %; 40 to 95 mole %; from 40 to 90 mole %; from 40 to 85 mole %; from 40 to 80 mole %; from 40 to 70 mole %; from 40 to 60 mole %; from 40 to 50 mole %; 50 to 100 mole %; from 50 to 99 mole %; 50 to 95 mole %; from 50 to 90 mole %; from 50 to 85 mole %; from 50 to 80 mole %; from 50 to 70 mole %; from 50 to 60 mole %; 60 to 100 mole %; from 60 to 99 mole %; 60 to 95 mole %; from 60 to 90 mole %; from 60 to 85 mole %; from 60 to 80 mole %; from 60 to 70 mole %; 70 to 100 mole %; from 70 to 99 mole %; 70 to 95 mole %; from 70 to 90 mole %; from 70 to 85 mole %; from 70 to 80 mole %; from 60 to 70 mole %; 80 to 100 mole %; from 80 to 99 mole %; 80 to 95 mole %; from 80 to 90 mole %; 90 to 100 mole %; from 90 to 99 mole %; 90 to 95 mole %; 95 to 100 mole %; or from 95 to 99 mole %.

The rigid polyesters useful in the invention can be any of the traditional compositions described as polyethylene terephthalate (PET), acid-modified polyethylene terephthalate (PETA), glycol modified PET (PETG), glycol modified poly(cyclohexylene dimethylene terephthalate) (PCTG), poly(cyclohexylene dimethylene terephthalate) (PCT), acid modified poly(cyclohexylene dimethylene terephthalate) (PCTA), and any of the foregoing polymers modified with 2,2,4,4-tetramethylcyclobutane-1,3-diol.

In one aspect, the rigid polyester useful in the polyester compositions of the invention comprises residues of isosorbide. In one embodiment, the isosorbide polymer can also comprise residues of ethylene glycol and/or cyclohexanedimethanol. In embodiments, the rigid polyester comprises residues of isosorbide and 1,4-cyclohexanedimethanol and optionally, ethylene glycol. In embodiments, the rigid polyester comprises residues of isosorbide and ethylene glycol and optionally, 1,4-cycloehexanedimethanol.

For terephthalate based rigid polyesters, terephthalic acid can be present in an amount of from 70 to 100 mole %. Modifying dicarboxylic acids may be present in an amount of up to 30 mole %. In one embodiment, the modifying dicarboxylic acid can be isophthalic acid. Aliphatic diacids can also be present in the terephthalic acid based polyesters of the invention.

In certain embodiments, the polyester compositions of the invention can include rigid copolyesters comprising residues of 70 to 100 mole % terephthalic acid, and optionally, 0.01 to 30 mole %, or 0.01 to 20 mole %, or 0.01 to 10 mole %, or 0.01 to 5 mole % of isophthalic acid, or esters there and/or mixtures thereof.

In certain embodiments, the polyester compositions of the invention can include rigid copolyesters comprising 1,4-cyclohexanedimethanol and, optionally, ethylene glycol. In certain embodiments, the polymer compositions of the invention can include rigid copolyesters comprising from 50 mole % to 100 mole %, or from 60 mole % to 100 mole %, or from 65 mole % to 100 mole %, or from 70 mole % to 100 mole %, or from 75 mole % to 100 mole %, or from 80 mole % to 100 mole %, or from 90 mole % from to 100 mole %, or 95 mole % to 100 mole %, of residues of 1,4-cyclohexanedimethanol and, optionally, from 0 mole % to 50 mole %, or from 0 mole % to 40 mole %, or from 0 mole % to 35 mole %, or from 0 mole % to 30 mole %, or from 0 mole % to 25 mole %, or from 0 mole % to 20 mole %, or from 0 mole % to 10 mole %, or from 0 mole % to 5 mole %, of residues of ethylene glycol.

In certain embodiments, the polyester compositions of the invention can include rigid copolyesters comprising residues of 99 to 100 mole % terephthalic acid and residues of 99 to 100 mole % 1,4-cyclohexanedimethanol. In certain embodiments, the rigid polyester comprises residues of diethylene glycol. In embodiments, the rigid polyester comprises residues of terephthalic acid, isophthalic acid and 1,4-cyclohexanedimethanol. In embodiments, the rigid polyester comprises from 50 mole % to 99.99 mole % of residues of 1,4-cyclohexanedimethanol, 0.01 mole % to 50 mole % of residues of ethylene glycol, and from 70 mole % to 100 mole % of residues of terephthalic acid. In embodiments, the rigid polyester comprises from 80 mole % to 99.99 mole % of residues of 1,4-cyclohexanedimethanol and 0.01 mole % to 20 mole % of residues of ethylene glycol. In embodiments, the rigid polyester comprises from 90 mole % to 99.99 mole % of residues of 1,4-cyclohexanedimethanol and 0.01 mole % to 10 mole % of residues of ethylene glycol. In embodiments, the rigid polyester comprises from 95 mole % to 99.99 mole % of residues of 1,4-cyclohexanedimethanol and 0.01 mole % to 5 mole % of residues of ethylene glycol. In embodiments, the rigid polyester comprises from 95 mole % to 99.99 mole % of residues of 1,4-cyclohexanedimethanol, 0.01 mole % to 10 mole % of residues of ethylene glycol, from 90 mole % to 100 mole % of residues of terephthalic acid, and 0.01 to 10 mole % of residues of isophthalic acid. In embodiments, the rigid polyester comprises from 95 mole % to 100 mole % of residues of 1,4-cyclohexanedimethanol, 0.01 mole % to 5 mole % of residues of ethylene glycol, from 95 mole % to 100 mole % of residues of terephthalic acid, and 0.01 to 5 mole % of residues of isophthalic acid. In embodiments, the rigid polyester consists essentially of residues of terephthalic acid or an ester thereof and 1,4-cyclohexanedimethanol. In embodiments, the rigid polyester comprising consist essentially of residues of terephthalic acid or an ester thereof, 1,4-cyclohexanedimethanol and ethylene glycol. In embodiments, the rigid polyester comprises 0 mole % to 30 mole % or 0 mole % to 20 mole % or 0 mole % to 10 mole % or 0 mole % to 5 mole % or 0.01 mole % to 30 mole % or 0.01 mole % to 20 mole % or 0.01 mole % to 10 mole % or 0.01 mole % to 5 mole % isophthalic acid residues, based on a total of 100 mole % acid residues and a total of 100 mole % of diol residues. In embodiments, the rigid polyester comprises from 20 mole % to less than 50 mole % of residues of 1,4-cyclohexanedimethanol, greater than 50 mole % to 80 mole % of residues of ethylene glycol, and from 70 mole % to 100 mole % of residues of terephthalic acid. In embodiments, the rigid polyester comprises from 20 mole % to 40 mole % of residues of 1,4-cyclohexanedimethanol, 60 mole % to 80 mole % of residues of ethylene glycol, and from 70 mole % to 100 mole % of residues of terephthalic acid. In embodiments, the rigid polyester comprises from 25 mole % to 40 mole % of residues of 1,4-cyclohexanedimethanol, 60 mole % to 75 mole % of residues of ethylene glycol, and from 70 mole % to 100 mole % of residues of terephthalic acid. In embodiments, the rigid polyester comprises from 25 mole % to 35 mole % of residues of 1,4-cyclohexanedimethanol, 65 mole % to 75 mole % of residues of ethylene glycol, and from 70 mole % to 100 mole % of residues of terephthalic acid. In embodiments, the rigid polyester comprises 0 to 20 mole % of residues of 1,4-cyclohexanedimethanol and 80 to 100 of residues of ethylene glycol.

In certain embodiments, the rigid polyester comprises residues of neopentyl glycol. In embodiments, the rigid polyester comprises 2,2,4,4-cyclobutanediol-1,3-cyclobutanediol residues.

In embodiments, the rigid polyester comprises from 0.01 to 99 mole % 2,2,4,4-tetramethyl-1,3-cyclobutanediol residues and from 0.01 to 99 mole % 1,4-cyclohexanedimethanol residues and 70 to 100 mole % terephthalic acid residues. In embodiments, the rigid polyester comprises from 20 to 40 mole % 2,2,4,4-tetramethyl-1,3-cyclobutanediol residues, from 20 to 40 mole % 1,4-cyclohexanedimethanol residues, 20 to 60 mole % of ethylene glycol residues. In embodiments, the rigid polyester comprises from 0.01 to 15 mole % 2,2,4,4-tetramethyl-1,3-cyclobutanediol residues. In embodiments, the rigid polyester comprises from 15 to 40 mole % 2,2,4,4-tetramethyl-1,3-cyclobutanediol residues and from 60 to 85 mole % 1,4-cyclohexanedimethanol residues. In embodiments, the rigid polyester comprises from 20 to 40 mole % 2,2,4,4-tetramethyl-1,3-cyclobutanediol residues and from 60 to 80 mole % 1,4-cyclohexanedimethanol residues. In embodiments, the rigid polyester comprises from 20 to 30 mole % 2,2,4,4-tetramethyl-1,3-cyclobutanediol residues and from 70 to 80 mole % 1,4-cyclohexanedimethanol residues and 70 to 100 mole % terephthalic acid residues. In embodiments, the rigid polyester comprises from 30 to 40 mole % 2,2,4,4-tetramethyl-1,3-cyclobutanediol residues and from 60 to 70 mole % 1,4-cyclohexanedimethanol residues and 70 to 100 mole % terephthalic acid residues.

In embodiments, the rigid polyester component comprises residues of 1,4-cyclohexanedicarboxylic acid or an ester thereof. In embodiments, the rigid polyester component comprises residues of dimethyl-1,4-cyclohexanedicarboxylate. In embodiments, the rigid polyester component comprises residues 1,4-cyclohexanedicarboxylic acid or an ester thereof in the amount of from 70 to 100 mole % or from 80 to 100 mole % or from 90 to 100 mole % or from 95 to 100 mole % or from 98 to 100 mole %, based on a total of 100 mole % acid residues and a total of 100 mole % diol residues.

In some aspects of the invention, the rigid copolyesters useful in the invention may comprise a diacid component comprising at least 70 mole % of residues of terephthalic acid, isophthalic acid, or mixtures thereof; and a diol component comprising (a) the residues of 2,2,4,4-tetramethyl-1,3-cyclobutanediol and residues of 1,4-cyclohexanedimethanol (TMCD Copolyesters).

In one embodiment, the rigid polyester can comprise from 0.01 to 99.99 mole % 2,2,4,4-tetramethyl-1,3-cyclobutanediol residues and 99.99 to 0.01 mole % 1,4-cyclohexanedimethanol residues, or from 20 to 50 mole % 2,2,4,4-tetramethyl-1,3-cyclobutanediol residues and 50 to 80 mole % 1,4-cyclohexanedimethanol residues, or from 20 to less than 50 mole % 2,2,4,4-tetramethyl-1,3-cyclobutanediol residues and greater than 50 to 80 mole % 1,4-cyclohexanedimethanol residues, or from 15 to 40 mole % 2,2,4,4-tetramethyl-1,3-cyclobutanediol residues and 60 to 85 mole % 1,4-cyclohexanedimethanol residues, or from 20 to 40 mole % 2,2,4,4-tetramethyl-1,3-cyclobutanediol residues and 60 to 80 mole % 1,4-cyclohexanedimethanol residues, or from 20 to 30 mole % 2,2,4,4-tetramethyl-1,3-cyclobutanediol residues and 70 to 80 mole % 1,4-cyclohexanedimethanol residues, or from 30 to 40 mole % 2,2,4,4-tetramethyl-1,3-cyclobutanediol residues and 60 to 70 mole % 1,4-cyclohexanedimethanol residues, or from 0.01 to 15 mole % 2,2,4,4-tetramethyl-1,3-cyclobutanediol residues and 85 to 99.99 mole % 1,4-cyclohexanedimethanol residues, or from 20 to 40 mole % 2,2,4,4-tetramethyl-1,3-cyclobutanediol residues, from 20 to 40 mole % 1,4-cyclohexanedimethanol residues and 20 to 60 mole % of ethylene glycol residues, and, for all of these ranges, optionally, 70 to 100 mole % terephthalic acid or isophthalic residues or mixtures thereof, based on a total of 100 mole % acid residues and a total of 100 mole % diol residues.

In one embodiment, the rigid polyester can comprise 20 to 40 mole % 2,2,4,4-tetramethyl-1,3-cyclobutanediol residues and 60 to 80 mole % 1,4-cyclohexanedimethanol residues and 70 to 100 mole % terephthalic acid residues, based on a total of 100 mole % acid residues and a total of 100 mole % diol residues.

In certain embodiments, the rigid polyester of the invention may can include copolyesters comprising diacids, wherein at least one diacid is selected from the group consisting of terephthalic acid and isophthalic acid, or esters there and/or mixtures thereof; and a diol component comprising: (a) from 20 to less than 50 mole % of 1,4-cyclohexanedimethanol and residues from greater than 50 to 80 mole % ethylene glycol residues; or from 20 to 40 mole % of 1,4-cyclohexanedimethanol residues and from 60 to 80 mole % ethylene glycol residues, or from 20 to 40 mole % of 1,4-cyclohexanedimethanol residues and from 60 to 80 mole % ethylene glycol residues, or from 25 to 40 mole % of 1,4-cyclohexanedimethanol residues and from 60 to 75 mole % ethylene glycol residues, or from 25 to 35 mole % of 1,4-cyclohexanedimethanol residues and from 65 to 75 mole % ethylene glycol residues (PETG); or (b) from 50 mole % to 99.99 mole %, or from 55 mole % to 99.99 mole %, or from 60 mole % to 99.99 mole %, or from 65 mole % to 99.99 mole %, or from 70 mole % to 99.99 mole %, or from 75 mole % to 99.99 mole %, or from 80 mole % to 99.99 mole %, or from 85 mole % to 99.99 mole % percent, or from 90 mole % from to 99.99 mole %, or 95 mole % to 99.99 mole %, of residues of 1,4-cyclohexanedimethanol and from 0.01 mole % to 50 mole %, or from 0.01 mole % to 45 mole %, or from 0.01 mole % to 40 mole %, or from 0.01 mole % to 35 mole %, or from 0.01 mole % to 30 mole %, or from 0.01 mole % to 25 mole %, or from 0.01 mole % to 20 mole %, or from 0.01 mole % to 15 mole %, or from 0.01 mole % to 10 mole %, or from 0.01 mole % to 5 mole %, of residues of ethylene glycol (PCTG); or (c) from 95 to 99.99 mole %, of residues of 1,4-cyclohexanedimethanol and from 0.01 to 10 mole % or from 0.01 to 5 mole % of residues of isophthalic acid, and from 0.01 to 10 mole % or from 0.01 to 5 mole % of residues of ethylene glycol (PCTA) or (d) 0 to 20 mole % of residues of 1,4-cyclohexanedimethanol and 80 to 100 mole % of residues of ethylene glycol (PET or glycol modified PET) or (e) isosorbide polymers comprising 1,4-cyclohexanedimethanol and optionally, ethylene glycol or (f) isosorbide polymers comprising ethylene glycol or (g) (PCT as defined herein). In certain embodiments, the diol component can comprise from 10 mole % to 40 mole %, or from 15 mole % to 35 mole %, or from 20 mole % to 35 mole %, or from 20 mole % to 30 mole %, or from 20 mole % to 40 mole %, or from 20 mole % to 35 mole %, of residues of isosorbide; from 30 mole % to 70 mole %, or from 40 mole % to 70 mole %, or from 45 mole % to 65 mole %, or from 45 mole % to 60 mole %, or from 45 mole % to 55 mole %, or from 47 mole % to 65 mole %, or from 48 mole % from to 65 mole %, or 49 mole % to 65 mole %, or 50 mole % to 65 mole %, or from 47 mole % to 60 mole %, or from 48 mole % from to 60 mole %, or 49 mole % to 60 mole %, or 50 mole % to 60 mole %, of residues of 1,4-cyclohexanedimethanol and, optionally, from 0 mole % to 40 mole %, or from 0 mole % to 35 mole %, or from 0 mole % to 30 mole %, or from 0 mole % to 25 mole %, or from 0 mole % to 20 mole %, or from 0 mole % to 15 mole %, or from 0 mole % to 10 mole %, or from 0 mole % to 5 mole %, of residues of ethylene glycol. In one embodiment, the diol component can comprise from 18 mole % to 35 mole %, or from 20 mole % to 35 mole %, of residues of isosorbide; from 40 mole % to 58 mole %, or from 45 mole % to 55 mole %, of residues of 1,4-cyclohexanedimethanol; and, from 15 mole % to 25 mole %, or from 20 mole % to 25 mole %, of residues of ethylene glycol.

In embodiments of the invention, the rigid polyester can comprise residues of a branching agent. In embodiments, the polyester or the polyester component of said polyesterether comprises 0.01 to 5 mole % or 0.01 to 4 mole % or from 0.01 to 3 mole % or from 0.01 to 2 mole % or from 0.01 to about 1.5 mole % or from 0.01 to 1 mole % or from 0.1 to 5 mole % or 0.1 to 4 mole % or from 0.1 to 3 mole % or from 0.1 to 2 mole % or from 0.1 to about 1.5 mole % or from 0.1 to 1 mole or from 0.5 to 5 mole % or 0.5 to 4 mole % or from 0.5 to 3 mole % or from 0.5 to 2 mole % or from 0.5 to about 1.5 mole % or from 0.5 to 1 mole % or from 1 to 5 mole % or 1 to 4 mole % or from 1 to 3 mole % or from 1 to 2 mole % of at least one branching agent or at least one polyfunctional branching agent, based on a total of 100 mole % acid residues and a total of 100 mole % diol residues. In embodiments, the polyfunctional branching agent has at least 3 carboxyl or hydroxyl groups. In embodiments, the polyfunctional branching agent comprises residues of trimellitic acid, trimellitic anhydride, trimesic acid, trimethyol ethane, trimethyolpropane, pentaerythritol, glycerine, tetra-maleaic anhydride, and trimer acid. In embodiments, the polyfunctional branching agent comprises residues of trimellitic anhydride, trimethyolpropane, pentaerythritol, glycerine, tetra-maleaic anhydride.

For certain embodiments of the invention, the rigid polyesters useful in the invention may exhibit at least one of the following inherent viscosities as determined in 60/40 (wt/wt) phenol/tetrachloroethane at a concentration of 0.5 g/100 ml at 25° C. per ASTM D4603: one of the following ranges: 0.35 to 1.5 dL/g; 0.35 to 1.2 dL/g; 0.35 to 1 dL/g; 0.50 to 1.5 dL/g; 0.50 to 1.2 dL/g; 0.50 to 1 dL/g; 0.50 to 0.95 dL/g, 0.50 to 0.90 dL/g, 0.50 to 0.85 dL/g; 0.50 to 0.80 dL/g; 0.50 to 0.75 dL/g; 0.50 to less than 0.75 dL/g; 0.50 to 0.72 dL/g; 0.50 to 0.70 dL/g; 0.50 to less than 0.70 dL/g; 0.50 to 0.68 dL/g; 0.50 to less than 0.68 dL/g; 0.50 to 0.65 dL/g; 0.55 to 1.5 dL/g; 0.55 to 1.2 dL/g; 0.55 to 1 dL/g; 0.55 to 0.85 dL/g; 0.55 to 0.80 dL/g; 0.55 to 0.78 dL/g; 0.55 to 0.75 dL/g; 0.55 to less than 0.75 dL/g; 0.55 to 0.72 dL/g; 0.55 to 0.70 dL/g; 0.55 to less than 0.70 dL/g; 0.55 to 0.68 dL/g; 0.55 to less than 0.68 dL/g; 0.55 to 0.65 dL/g; 0.60 to 1.5 dL/g; 0.60 to 1.3 dL/g; 0.60 to 1.2 dL/g; 0.60 to 1.1 dL/g, 0.60 to 1.0 dL/g, 0.60 to 0.95 dL/g, 0.60 to 0.90 dL/g, 0.60 to 0.85 dL/g 0.60 to 0.80 dL/g; 0.60 to 0.75 dL/g; 0.60 to 0.68 dL/g; 0.70 to 1.5 dL/g 0.70 to 1.2 dL/g; 0.80 to 1.5 dL/g; and 0.80 to 1.2 dL/g.

It is contemplated that the rigid polyester of the invention can possess at least one of the inherent viscosity ranges described herein and at least one of the monomer ranges for the compositions described herein unless otherwise stated. It is also contemplated that the rigid polyester of the invention can possess at least one of the Tg ranges described herein and at least one of the monomer ranges for the compositions described herein unless otherwise stated. It is also contemplated that the rigid polyester of the invention can possess at least one of the Tg ranges described herein, at least one of the inherent viscosity ranges described herein and at least one of the monomer ranges for the compositions described herein unless otherwise stated.

In another embodiment of the invention, the rigid polyester comprises at least one diacid residue selected from the group consisting of terephthalic acid, isophthalic acid, naphthalene dicarboxylic acid, cyclohexane dicarboxylic acid and at least one diol selected from the group consisting of ethylene glycol, diethylene glycol, cyclohexane dimethanol, 2,2,4,4 tetramethyl cyclobutane 1,3 diol, isosorbide, neopentyl glycol, and butane diol.

The amount of the rigid polyester in the polyester composition can range from about 1 to about 99% by weight based on the weight of the polyester composition. In other embodiments, the amount of rigid polyester in the polyester composition can range from about 10 to about 90 by weight, from about 20 to about 80 by weight, about 30 to about 70 by weight, from about 40 to about 60 by weight based on the weight of the polyester composition.

### Polyester Elastomer

The polyester elastomer used in the polyester composition of this invention can be any known in the art having a Tg of 50° C. or less. In one embodiment, the polyester elastomer comprises at least one dicarboxylic acid; at least one dihydroxy alcohol; at least one polyol; and optionally a multi-functionalized acid, alcohol or anhydride branching agent; wherein the polyester elastomer has a Tg of 50° C. or less. In other embodiments, the Tg of the polyester elastomer can be 45° C. or less, or 40° C. or less, or 35° C. or less, 30° C. or less, 25° C. or less, 20° C. or less, 15° C. or less, 10° C. or less, 5° C. or less, 0° C. or less, −5° C. or less, −10° C. or less, −15° C. or less, −20° C. or less, −25° C. or less, −30 C or less, −35 C or less, −40 C or less, −50 C or less, −55 C or less, −60 C or less, −70 C or less, and −80 or less. The Tg of the polyester elastomer can also range from 50° C. to −80° C., 45° C. to −80° C., 40° C. to −80° C., 35° C. to −80° C., 30° C. to −80° C., 25° C. to −80° C., 20° C. to −80° C., 15° C. to −80° C., 10° C. to −80° C., 5° C. to −80° C., 0° C. to −80° C., −5° C. to −80° C., −10° C. to −80° C., −15° C. to −80° C., −20° C. to −80° C., −25° C. to −80° C., −30° C. to −80° C., −40° C. to −80° C., −50° C. to −80° C., −60° C. to −80° C., 50° C. to −75° C., 45° C. to −75° C., 40° C. to −75° C., 35° C. to −75° C., 30° C. to −75° C., 25° C. to −75° C., 20° C. to −75° C., 15° C. to −75° C., 10° C. to −75° C., 5° C. to −75° C., 0° C. to −75° C., −5° C. to −75° C., −10° C. to −75° C., −15° C. to −75° C., −20° C. to −75° C., −25° C. to −75° C., −30° C. to −75° C., −40° C. to −75° C., −50° C. to −75° C., −60° C. to −75° C., 50° C. to −70° C., 45° C. to −70° C., 40° C. to −70° C., 35° C. to −70° C., 30° C. to −70° C., 25° C. to −70° C., 20° C. to −70° C., 15° C. to −70° C., 10° C. to −70° C., 5° C. to −70° C., 0° C. to −70° C., −5° C. to −70° C., −10° C. to −70° C., −15° C. to −70° C., −20° C. to −70° C., −25° C. to −70° C., −30° C. to −70° C., −40° C. to −70° C., −50° C. to −70° C., and −60° C. to −70° C.

The polyester elastomer can have a flexural modulus of less than 1000 Mpa, less than 950 Mpa, less than 900 Mpa, less than 850 Mpa, less than 800 Mpa, less than 750 Mpa, less than 700 Mpa, Less than 650 Mpa, Less than 600 Mpa, less than 550 Mpa, less than 500 Mpa, less than 450 Mpa, less than 400 Mpa, less than 350 Mpa, less than 300 Mpa, less than 250 Mpa, less than than 200 Mpa, less than 150 Mpa, less than 100 Mpa, less than 50 Mpa according to ASTM D790 at 25° C. In other embodiments of the invention, the polyester elastomer can have a flexural modulus ranging from 25 Mpa to 1000 Mpa, 50 Mpa to 1000 Mpa, 100 Mpa, to 1000 Mpa, 150 Mpa to 1000 Mpa, 200 Mpa to 1000 Mpa, 250 Mpa to 1000 Mpa, 300 Mpa to 1000 Mpa, 350 Mpa to 1000 Mpa, 400 Mpa to 1000 Mpa, 450 Mpa to 1000 Mpa, 500 Mpa to 1000 Mpa, 550 Mpa to 1000 Mpa, 600 Mpa to 1000 Mpa, 650 Mpa to 1000 Mpa, 700 Mpa to 1000 Mpa, 750 Mpa to 1000 Mpa, 800 Mpa to 1000 Mpa, 25 Mpa to 9000 Mpa, 50 Mpa to 900 Mpa, 100 Mpa, to 900 Mpa, 150 Mpa to 900 Mpa, 200 Mpa to 900 Mpa, 250 Mpa to 900 Mpa, 300 Mpa to 900 Mpa, 350 Mpa to 900 Mpa, 400 Mpa to 900 Mpa, 450 Mpa to 900 Mpa, 500 Mpa to 900 Mpa, 550 Mpa to 900 Mpa, 600 Mpa to 900 Mpa, 650 Mpa to 900 Mpa, 700 Mpa to 900 Mpa, 750 Mpa to 900 Mpa, 25 Mpa to 800 Mpa, 50 Mpa to 800 Mpa, 100 Mpa, to 800 Mpa, 150 Mpa to 800 Mpa, 200 Mpa to 800 Mpa, 250 Mpa to 800 Mpa, 300 Mpa to 800 Mpa, 350 Mpa to 800 Mpa, 400 Mpa to 800 Mpa, 450 Mpa to 800 Mpa, 500 Mpa to 800 Mpa, 550 Mpa to 800 Mpa, 600 Mpa to 800 Mpa, 650 Mpa to 800 Mpa, 700 Mpa to 800 Mpa, 25 Mpa to 700 Mpa, 50 Mpa to 700 Mpa, 100 Mpa, to 700 Mpa, 150 Mpa to 700 Mpa, 200 Mpa to 700 Mpa, 250 Mpa to 700 Mpa, 300 Mpa to 700 Mpa, 350 Mpa to 700 Mpa, 400 Mpa to 700 Mpa, 450 Mpa to 700 Mpa, 500 Mpa to 700 Mpa, 550 Mpa to 700 Mpa, and 600 Mpa to 700 Mpa according to ASTM D790 at 25° C.

In some embodiments of this invention, the polyester elastomer comprises residues of at least one dicarboxylic acid compound, its diester derivative, its anhydride, or a combination thereof. The dicarboxylic acid compounds are capable of forming ester linkages with diol or polyol compounds.

In some embodiments of this invention, the polyester elastomer comprises residues of alicyclic diacids such as, but are not limited to, hexahydrophthalic anhydride (HHPA), tetrahydrophthalic anhydride, tetrachlorophthalic anhydride, 5-norbornene-2,3-dicarboxylic anhydride, 5-norbornene-2,3-dicarboxylic acid, 2,3-norbornanedicarboxylic acid, 2,3-norbornanedicarboxylic acid anhydride, cyclohexane dicarboxylic acid (including the 1, 2-; 1,3-; and 1,4-isomers) (CHDA), dimethylcyclohexane (including the 1, 2-; 1,3-; and 1,4-isomers) (DMCD) and mixtures thereof.

In some embodiments of this invention, the polyester elastomer comprises residues of acyclic aliphatic diacids such as, but are not limited to adipic acid, maleic anhydride, maleic acid, fumaric acid, itaconic anhydride, itaconic acid, citraconic anhydride, citraconic acid, dodecanedioic acid, succinic acid, succinic anhydride, glutaric acid, sebacic acid, azelaic acid, and mixtures thereof.

In some embodiments of the invention, the polyester elastomer comprises residues of di-alcohol components such as, but are not limited to 2,2,4,4-tetraalkylcyclobutane-1,3-diol (such as 2,2,4,4-tetramethylcyclobutane-1,3-diol), 2,2-dimethyl-1,3-propanediol (neopentyl glycol), 1,2 cyclohexanedimethanol, 1,3-cyclohexanedimethanol, 1,4 cyclohexanedimethanol, 2,2,4-trimethyl-1,3-pentanediol, hydroxypivalyl hydroxypivalate, 2-methyl-1,3-propanediol, 2-butyl-2-ethyl-1,3-propanediol, 2-ethyl-2-isobutyl-1,3-propanediol, 1,3-butanediol, 1,4-butanediol, 1,5-pentanediol, 1,6-hexanediol, 2,2,4,4-tetramethyl-1,6-hexanediol, 1,10-decanediol, 1,4-benzenedimethanol, ethylene glycol, propylene glycol, diethylene glycol, dipropylene glycol, triethylene glycol, and tetraethylene glycol.

In some embodiments of this invention, the polyester elastomer comprises residues of at least one polyol. The polyol includes, but is not limited to, polytetramethylene ether glycol (PTMG), polyethylene glycol, polypropylene glycol, or any other polyether polyols and mixtures thereof. A polyol is an organic compound containing multiple hydroxyl groups. A molecule with more than two hydroxyl groups is a polyol, with three is a triol, one with with four is a tetrol and so on. By convention, polyols do not refer to compounds that contain other functional groups. Polyols typically have weight average molecular weights (Mw) of about 500 to 5000 with Mw's of about around 1000 to 2000 preferred. In embodiments, hydroxyl functionalities, meaning the number of hydroxyl groups as polymer end groups, can range from about 1.9 to about 2.1 for thermoplastic materials and from about 2.1 and higher for crosslinked materials.

In some embodiments of this invention, the polyester elastomer may include at least one optional branching agent such as multi-functionalized acids, alcohols, anhydrides and combinations thereof.

In some embodiments of this invention, the optional branching agent includes, but is not limited, to 1,1,1-trimethylol propane, 1,1,1-trimethylolethane, glycerin, pentaerythritol, erythritol, threitol, dipentaerythritol, sorbitol, neopentyl glycol, phenyl dianhydride, hexanediol, trimelletic anhydride (TMA) and combinations thereof.

In some embodiments of the invention, the diacid component of the polyester elastomer can include cyclohexane dicarboxylic acid (CHDA), and dimethylcyclohexane (DMCD), and combinations thereof, the diglycol component of the polyester includes cyclohexane dimethanol (CHDM), and the polyol includes polytetramethylene ether glycol (PTMG).

In some embodiments of the invention, the diacid component of the polyester elastomer includes cyclohexane dicarboxylic acid (CHDA), and dimethylcyclohexane (DMCD), and combinations thereof, the diglycol component of the polyester includes cyclohexane dimethanol (CHDM), the polyol includes polytetramethylene ether glycol (PTMG), and the branching agent includes trimelletic anhydride (TMA).

The polyester elastomer in the inventive polyester composition can be a thermoplastic copolyester ether elastomer. Thermoplastic copolyester ether elastomers have high flexibility without plasticizers, very high clarity, excellent toughness and puncture resistance, outstanding low temperature strength and excellent flex crack & creep resistance. In one embodiment, the thermoplastic copolyester ether elastomer is poly(cyclohexylene dimethylene cyclohexanedicarboxylate) (PCCE), manufactured by the reaction of dimethylcyclohexane dicarboxylate with cyclohexane dimethanol and polytetramethylene glycol.

The invention thus relates to the use of polyester compositions that may comprise thermoplastic copolyester ethers that are elastomers, and especially elastomers that are high molecular weight semi-crystalline thermoplastic copolyester ethers manufactured by the reaction of dimethylcyclohexane dicarboxylate with cyclohexane dimethanol and polytetramethylene glycol. The copolyester ethers useful according to the invention have high flexibility without plasticizers, very high clarity, excellent toughness and puncture resistance, outstanding low temperature strength, and excellent flex, crack, and creep resistance.

Copolyester ethers useful according to the invention include those disclosed in U.S. Pat. Nos. 4,349,469 and 4,939,009, the disclosures of which are incorporated herein by reference. The copolyester ethers useful according to the invention are tough, flexible materials that can be extruded into clear sheets. They include copolyester ethers based on 1,4-cyclohexanedicarboxylic acid or an ester thereof, 1,4-cyclohexanedimethanol, and poly(oxytetramethylene) glycol, also known as polytetramethylene ether glycol. The copolyester ethers useful according to the invention include those available commercially from Eastman Chemical Company, Kingsport, TN, under the ECDEL brand.

In one aspect, the copolyester ethers may have an Inherent Viscosity (I.V.), for example, from about 0.8 to 1.5, and recurring units from (1) a dicarboxylic acid component comprising 1,4-cyclohexanedicarboxylic acid or an ester thereof typically having a trans isomer content of at least 70%, or at least 80%, or at least 85%; (2) a glycol component comprising, for example, (a) about 95 to about 65 mol % 1,4-cyclohexanedimethanol, and (b) about 5 to about 50 mol % poly(oxytetramethylene) glycol, or 10 to 40 mol %, or 15 to 35 mol %, having a molecular weight for example, from about 500 to about 1200, or from 900 to 1,100, in both cases being weight average molecular weight.

Alternatively, the copolyester ethers may have an I.V., for example, from about 0.85 to about 1.4, or from 0.9 to 1.3, or from 0.95 to 1.2. As used herein, the I.V. is determined by dissolving a sample of the polymer in a solvent, measuring the flow rate of the solution through a capillary and then calculating the I.V. based on flow. Specifically, ASTM D4603-18, Standard Test Method for Determining Inherent Viscosity of Poly(Ethylene Terephthalate) (PET) by Glass Capillary Viscometer, may be used to determine I.V.

In addition to 1,4-cyclohexanedimethanol, other typical aliphatic or cycloaliphatic diols having 2 to 10 carbon atoms that are useful in forming the copolyester ethers include those such as ethylene glycol, diethylene glycol, triethylene glycol, tetraethylene glycol, pentaethylene glycol, 1,2-propylene glycol, 1.4-propylene glycol, dipropylene glycol, 1,2-butanediol, 1,3-butanediol, 1,4-butanediol, 1,5-pentanediol, 1,6-hexanediol, 1,2-cyclohexanedimethanol, 1,3-cyclohexanedimethanol, 2,2-dimethyl-1,3-propanediol (neopentyl glycol), 2-ethyl-2-isobutyl-1,3-propanediol, 2-methyl-1,3-propanediol, 2-butyl-2-ethyl-1,3-propanediol, 2,2,4-trimethyl-1,3-pentanediol, 2,2,4,4-tetramethyl-1,3-cyclobutanediol, 2,2,4,4-tetramethyl-1,6-hexanediol, 1,10-decanediol, 1,4-benzenedimethanol, hydroxypivalyl hydroxypivalate, and combinations thereof and the like. Although minor amounts of aromatic diols may be used, this may not be preferred.

In addition to 1,4-cyclohexanedicarboxylic acid, other aliphatic, cycloaliphatic or aromatic diacids or dianhydrides having 2 to 10 carbon atoms that are useful in forming the copolyester ethers include those such as adipic acid, maleic anhydride, maleic acid, fumaric acid, itaconic anhydride, itaconic acid, citraconic anhydride, citraconic acid, dodecanedioic acid, succinic acid, succinic anhydride, glutaric acid, sebacic acid, azelaic acid, terephthalic acid, isophthalic acid, stilbene dicarboxylic acid, bibenzoic acid hexahydrophthalic anhydride (HHPA), tetrahydrophthalic anhydride, tetrachlorophthalic anhydride, 5-norbornene-2,3-dicarboxylic anhydride, 5-norbornene-2,3-dicarboxylic acid, 2,3-norbornanedicarboxylic acid, 2,3-norbornanedicarboxylic acid anhydride, dimethylcyclohexane dicaboxylate (DMCD) and combinations thereof and the like. Aliphatic acids or anhydrides are preferred

In addition to polytetramethylene ether glycol, other useful polyether polyols having 2-4 carbon atoms between ether units include polyethylene ether glycol, and polypropylene ether glycol, and combinations thereof. For the purposes of this document, the term “polyol” refers to “polymeric diols”. Useful commercially available polyether polyols include Carbowax resins, Pluronics resins, and Niax resins. Polyether polyols useful according to the invention include those that may be characterized generally as polylakylene oxides, and may have a molecular weight, for example, from about 300 to about 10,000 or 500 to 2000.

The copolyester ethers further may comprise, for example, up to about 1.5 mol %, based on the acid or glycol component, of a polybasic acid or polyhydric alcohol branching agent having at least three —COH or —OH functional groups and from 3 to 60 carbon atoms. Esters of many such acids or polyols may also be used. Suitable branching agents include 1,1,1-trimethylol propane, 1,1,1-trimethylolethane, glycerin, pentaerythritol, erythritol, threitol, dipentaerythritol, sorbitol, phenyl dianhydride, trimellitic acid or anhydride, trimesic acid, and trimer acid.

It should be understood that the total acid reactants should be 100%, and the total glycol reactants should be 100 mol %. Although the acid reactant is said to comprise 1,4-cyclohexanedicarboxylic acid, if the branching agent is a polybasic acid or anhydride, it will be calculated as part of the 100 mol % acid. Likewise, the glycol reactant is said to comprise 1,4-cyclohexanedimethanol and poly(oxytetramethylene) glycol, if the branching agent is a polyol, it will be calculated as part of the 100 mol % glycol.

The trans and cis isomer contents of the final copolyester ethers may be controlled in order to give polymers that setup or crystallize rapidly. Cis- and trans-isomer contents are measured by conventional methods known to those skilled in the art. See, for example, U.S. Pat. No. 4,349,469.

Especially suitable copolyester ethers useful according to the invention are copolyester ethers based on 1,4-cyclohexanedicarboxylic acid, 1,4-cyclohexanedimethanol, and polytetramethylene ether glycol or other polyalkylene oxide glycol. In one aspect, the 1,4-cyclohexanedicarboxylic acid is present in an amount of at least 50 mol %, or at least 60 mol %, or at least 70 mol %, or at least 75 mol %, or at least 80 mol %, or at least 85 mol %, or at least 90 mol %, or at least 95 mol %, in each case based on the total amount of dicarboxylic acids present in the copolyester ether. In another aspect, the 1,4-cyclohexanedimethanol is present in an amount of from about 60 mol % to about 98 mol %, or from 65 mol % to 95 mol %, or from 70 mol % to 90 mol %, or from 75 mol % to 85 mol %, in each case based on the total amount of glycol. In another aspect, the polytetramethylene ether glycol is present in the copolyester ethers in an amount from about 2 to about 40 mol %, or from 5 mol % to 50 mol %, or from 7 mol % to 48 mol %, or from 10 mol % to 45 mol %, or from 15 to 40 mol %, or from 20 mol % to 35 mol %, in each case based on the total amount of glycol present.

In a further aspect, the amount of 1,4-cyclohexanedicarboxylic acid is from about 100 mol % to about 98 mol %, the amount of 1,4-cyclohexanedimethanol is from about 80 mol % to about 95 mol %, and the amount of polytetramethylene ether glycol is from about 5 mol % to about 20 mol %, and trimellitic anhydride may be present in an amount from 0.1 to 0.5 mol % TMA.

In a more specific aspect, the amount of 1,4-cyclohexanedicarboxylic acid is from 98 mol % to 100 mol %, the amount of 1,4-cyclohexanedimethanol is from 70 mol % to 95 mol %, and the amount of polytetramethylene ether glycol is from 5 mol % to 30 mol %, and trimellitic anhydride may be present in an amount from 0 to 0.5 mol %.

In yet another specific aspect, the amount of 1,4-cyclohexanedicarboxylic acid is from 99 mol % to 100 mol %, the amount of 1,4-cyclohexanedimethanol is from 70 mol % to 95 mol %, and the amount of polytetramethylene ether glycol is from 5 mol % to 30 mol %, and trimellitic ahydride may be present in an amount from 0 mol % to 1 mol %.

The copolyester ethers utilized in the polyester composition of this invention may include a phenolic antioxidant that is capable of reacting with the polymer intermediates. This causes the antioxidant to become chemically attached to the copolyester ether and be essentially nonextractable from the polymer. Antioxidants useful in this invention may contain one or more of an acid, hydroxyl, or ester group capable of reacting with the reagents used to prepare the copolyester ether. It is preferred that the phenolic antioxidant be hindered and relatively non-volatile. Examples of suitable antioxidants include hydroquinone, arylamine antioxidants such as 4,4′-bis(.alpha., .alpha.-dimethylbenzyl)diphenylamine, hindered phenol antioxidants such as 2,6-di-tert-butyl-4-methylphenol, butylated p-phenyl-phenol and 2-(.alpha.-methylcyclohexyl)-4,6-dimethylphenol; bis-phenols such as 2,2′-methylenebis-(6-tert-butyl-4-methylphenol), 4,4′bis(2,6-di-tert-butylphenol), 4,4′-methylenebis(6-tert-butyl-2-methylphenol), 4,4′-butylene-bis(6-tert-butyl-3-methylphenol), methylenebis-(2,6di-tertbutylphenol), 4,4′-thiobis(6-tert-butyl-2-methylphenol), and 2,2′-thiobis(4-methyl-6-tert-butylphenol); tris-phenols such as 1,3,5-tris(3,5-di-tert-butyl-4-hydroxyhydrocinnamoyl)-hexahydro-s-triazine, 1,3,5-trimethyl-2,4,6-tris(3,5-di-tert-butyl-4-hydroxybenzyl)benzene and tri(3,5-di-tert-butyl-4-hydroxyphenyl)phosphite; and tetrakis[methylene(3,5-di-tert-butyl-4-hydroxyhydrocinnamate)methane] which is commercially available from Geigy Chemical Company as Irganox 1010 antioxidant, is preferred. Preferably, the antioxidant is used in an amount of from about 0.1 to about 1.0, based on the weight of copolyester ether.

Copolyester ethers used in the polyester composition of this invention include those characterized by their good melt strength. A polymer having melt strength is described as one capable of supporting itself on being extruded downward from a die in the melt. When a polymer with melt strength is extruded downward, the melt will hold together. When a polymer without melt strength is extruded downward, the melt rapidly drops and breaks. For purposes of comparison, the melt strength is measured at a temperature 20° C. above the melting peak.

In another embodiment of the invention the polyester elastomer comprises the residues of:
a. cyclohexane dicarboxylic acid (CHDA), and dimethylcyclohexane (DMCD);
b. cyclohexane dimethanol (CHDM),
c. polytetramethylene ether glycol (PTMG), and
d. trimelletic anhydride (TMA)

In yet another embodiment of the invention, the polyester elastomer comprises:
a. 99 to 100 mole percent, based on the total molar acid content of the polyester, of a diacid selected from the group consisting of cyclohexane dicarboxylic acid (CHDA), dimethylcyclohexane dicarboxylic acid (DMCD), and combinations thereof;
b. 75 to 92 mole percent of cyclohexane dimethanol and 8 to 25 mole percent of polytetramethylene ether glycol based on the total glycol content of the polyester;
c. optionally up to 1 mole percent of a branching agent selected from the group consisting of glycerin, pentaerythritol, phenyl dianhydride, trimellitic anhydride and combinations thereof based on the total molar acid content of the polyester.

In yet another embodiment the invention comprises a polyester elastomer for low shear polymer melt processes comprising the residues of:
a. 99 to 100 mole percent, based on the total molar acid content of the polyester, of a diacid selected from the group consisting of a cyclohexane dicarboxylic acid, a dimethylcyclohexane dicarboxylic acid, and combinations thereof;
b. 75 to 92 mole percent of 1,4-cyclohexane dimethanol and 4 to 25 mole percent of polytetramethylene ether glycol based on the total glycol content of the polyester; and
c. optionally up to 1 mole percent of a branching agent selected from the group consisting of glycerin, pentaerythritol, phenyl dianhydride, trimellitic anhydride and combinations thereof based on the total molar acid content of the polyester.

In another embodiment, the polyester elastomer is Ecdel™ copolyester available commercially from Eastman Chemical Company, which are copolyesters based on a combination of cyclohexane dicarboxylic acid (CHDA) and cyclohexane dimethanol with polytetramethylene ether glycol having a molecular weight of 1000 (PTMG 1000). In the polyester synthesis process, CHDA and/or dimethylcyclohexane dicarboxylic acid (DMCD) can be used depending on the process. Trimelletic anhydride (TMA) can be used in the formula up to about 1%.

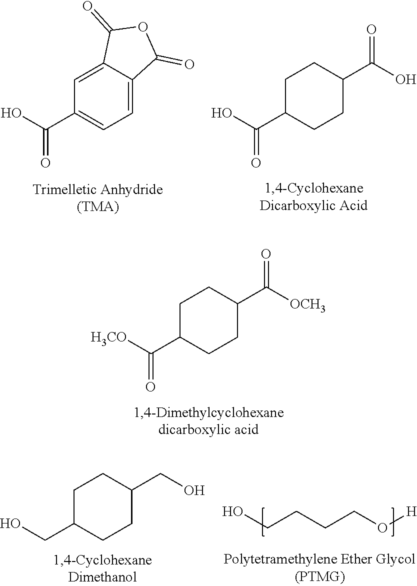

The amount of the polyester elastomer in the polyester composition can range from about 1 to about 99% by weight based on the weight of the polyester composition. In other embodiments, the amount of polyester elastomer in the polyester composition can range from about 10 to about 90 by weight, from about 80 to about 20 by weight, about 70 to about 30 by weight, from about 60 to about 40 by weight based on the weight of the polyester portion of the composition.

The present invention involves the use of primary antioxidants, secondary antioxidants and chain extending additives to inhibit the thermal oxidative and hydrolytic degradation of polymers held at elevated temperatures for extended periods of time and improve polymer flow. This combination has been shown to be effective in the polyester and copolyester classes of polymers. The improved thermal oxidative and hydrolytic stability can be measured using gel-permeation chromatography and through visual color observations and spectrophotography. Viscosity improvements can be measured using parallel plate rheometry.

In one embodiment of the present invention, the polyester composition comprises at least one primary antioxidant of the hindered phenol type, at least one secondary antioxidant in the phosphite family and at least one chain extending agent with epoxide functionalities. During exposure to high temperatures, polymers undergo chain cleavage which results in the formation of free radical molecules and carboxylic acids which are highly reactive and will lead to autocatalytic degradation of the polymer. In addition, the free radicals can also, in the presence of oxygen, react to create hydroxy, peroxy, peroxide, and mono and di-hydroxy terephthalates which are also very reactive and will lead to further polymer degradation. Primary antioxidants are added to react with free radicals thus inhibiting further degradation or reacting with oxygen to create hydroxy, peroxy, and other oxygen containing radicals. Secondary antioxidants, also known as oxygen scavengers, react with the hydroxy, peroxy and oxygen radicals before they can cause further polymer degradation.

Condensation polymers are also susceptible to hydrolytic degradation if not pre-dried or if they are held at elevated temperatures in moist air for a long period of time. Condensation polymers are any polymer where monomers form together to create a polymer and a by-product such as water or methanol is produced. The polymerization reaction is reversible; thus, condensation polymers must be pre-dried before processing.

### Primary Antioxidants

Hindered phenols and hindered amines are the main types of primary antioxidants used in thermoplastics. Typical hindered phenol and amine structures are shown below:

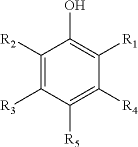

wherein

R₁ and R₂ are independently selected from the group consisting of H, CH₃, CH₂(CH₂)ₙCH₃, C(CH₃)₃, and CH(CH₃)₂, with n=0 to 5 and with the proviso that only either R₁ or R₂ can be H, and

R₃, R₄, R₅ are independently H or an organic residue.

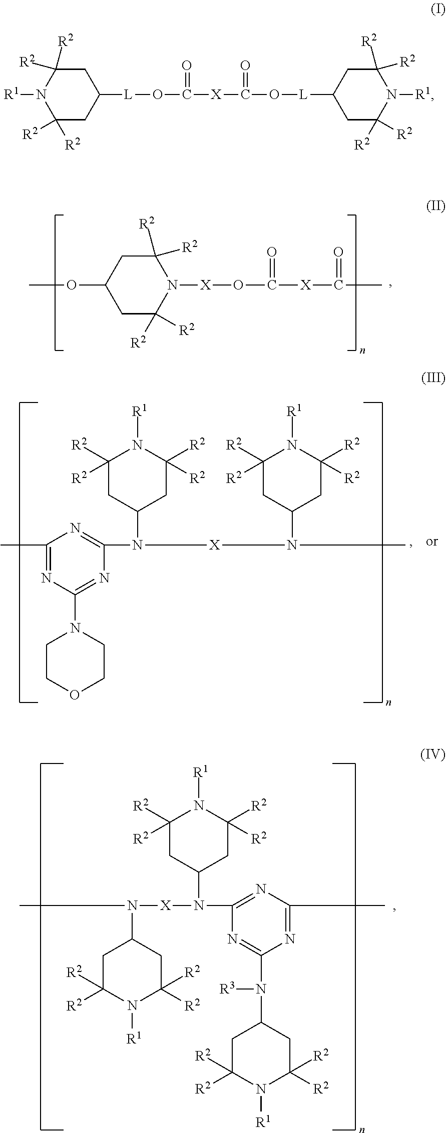

wherein:

each X is independently selected from the group consisting of C₁-C₂₀ alkyl and C₁-C₂₀ alkenyl;

L, in each instance, is absent or is independently selected from the group consisting of C₁-C₂₀ alkyl and C₁-C₂₀ alkenyl;

each R₁ is independently selected from the group consisting of C₁-C₂₀ alkyl, C₁-C₂₀ alkenyl, —O(C₁-C₂₀ alkyl), and —O(C₁-C₂₀ alkenyl);

each R₂ is independently selected from the group consisting of hydrogen, C₁-C₂₀ alkyl, and C₁-C₂₀ alkenyl;

each R₃ is independently selected from the group consisting of hydrogen, C₁-C₂₀ alkyl, and C₁-C₂₀ alkenyl; and

n is an integer selected from 1 to 50.

Several characteristics must be considered in the choice of a hindered phenol including the relative phenol content, which affects its reactivity, and the molecular weight with higher being better to ensure that the antioxidant does not migrate easily out of the polymer. Similarly, the weight effectiveness, the compatibility and the basicity must be considered in the choice of a hindered amine.

Several characteristics can be considered in the choice of a hindered phenolic antioxidant including the relative phenol content, which affects its reactivity, and the molecular weight sufficiently high to ensure that the antioxidant does not migrate easily out of the polymer.

In one embodiment, the phenolic antioxidant can be sterically hindered and/or relatively non-volatile. Examples of suitable phenolic antioxidants include hydroquinone, arylamine antioxidants such as 4,4′-bis(α,α-dimethylbenzyl)diphenylamine, hindered phenol antioxidants such as 2,6-di-tert-butyl-4-methylphenol, butylated p-phenyl-phenol and 2-(α-methylcyclohexyl)-4,6-dimethylphenol; bis-phenols such as 2,2′-methylenebis-(6-tert-butyl-4-methylphenol), 4,4′bis(2,6-di-tert-butylphenol), 4,4′-methylenebis(6-tert-butyl-2-methylphenol), 4,4′-butylene-bis(6-tert-butyl-3-methylphenol), methylenebis(2,6di-tertbutylphenol), 4,4′-thiobis(6-tert-butyl-2-methylphenol), and 2,2′-thiobis(4-methyl-6-tert-butylphenol); tris-phenols such as 1,3,5-tris(3,5-di-tert-butyl-4-hydroxyhydrocinnamoyl)-hexahydro-s-triazine, 1,3,5-trimethyl-2,4,6-tris(3,5-di-tert-butyl-4-hydroxybenzyl)benzene and tri(3,5-di-tert-butyl-4-hydroxyphenyl)phosphite; and pentaerythritol tetrakis[3-(3,5-di-t-butyl-4-hydroxyphenyl)propionate] the last of which is commercially available as Irganox™ 1010 antioxidant.

In a still further aspect, the primary antioxidant is selected from at least one hindered phenol, at least one secondary aryl amine, or a combination thereof.

In a further aspect, the at least one hindered phenol useful in the polyestercompositions of the invention comprises one or more compounds selected from triethylene glycol bis[3-(3-t-butyl-5-methyl-4-hydroxyphenyl)propionate], 1,6-hexanediolbis[3-(3,5-di-t-butyl-4-hydroxyphenyl)propionate], 2,4-bis(n-octylthio)-6-(4-hydroxy-3,5-di-t-butylanilino)-1,3,5-triazine, pentaerythrityl tetrakis[3-(3,5-di-t-butyl-4-hydroxyphenyl)propionate], 2,2-thiodiethylene bis[3-(3,5-di-t-butyl-4-hydroxyphenyl)propionate], octadecyl 3-(3,5-di-t-butyl-4-hydroxyphenyl)propionate, benzenepropanoic acid 3,5-bis(1,1-dimethylethyl)-4-hydroxy-2,2-bis[[3-[3,5-bis(1,1-dimethylethyl)-4-hydroxyphenyl]-1-oxopropoxy]methyl]-1,3-propanediyl ester, N,N′-hexamethylene bis(3,5-di-t-butyl-4-hydroxy-hydrocinnamamide), tetrakis(methylene 3,5-di-tert-butyl-hydroxycinnamate)methane, 4-[[4,6-bis(octylthio)-1,3,5-triazin-2-yl]amino]-2,6-bis(1,1-dimethylethyl)phenol (Irganox®565), and octadecyl 3,5-di-tert-butylhydroxyhydrocinnamate.

In one embodiment, the phenolic antioxidants useful in the polyester compositions of the invention can be octadecyl-3-(3,5-di-tert.butyl-4-hydroxyphenyl)-propionate (CAS number 2082-79-3; pentaerythritol tetrakis[3-(3,5-di-t-butyl-4-hydroxyphenyl)propionate] (CAS #6683-198, otherwise known as Irganox™ 1010); N,N′-hexane-1,6-diyl-bis[3-[3,5-ditert-butyl-4-hydroxyphenyl]propionamide] (CAS #23128-747-, Irganox™1098); benzenepropanoic acid 3,5-bis(1,1-dimethylethyl)-4-hydroxyoctadecyl ester (Irganox™1076). The Irganox phenolic brand of additives can be commercially obtained from BASF). In a further aspect, the hindered phenol comprises octadecyl-3-(3,5-di-t-butyl-4-hydroxyphenyl)-propionate. In an even further aspect, at least one hindered phenol is 3,5-bis(1,1-dimethylethyl)-4-hydroxy-2,2-bis[[3-[3,5-bis(1,1-dimethylethyl)-4-hydroxyphenyl]-1-oxopropoxy]methyl]-1,3-propanediyl ester.

In one embodiment, the phenolic antioxidant is present in the amount of from 0.01 to 5 weight %, or from 0.01 weight % to 4 weight %, or from 0.01 weight % to 3 weight %, or from 0.01 weight % to 2.0 weight %, or from 0.01 weight % to 1.0 weight %, or from 0.01 weight % to 0.90 weight %, or from 0.01 weight % to 0.80 weight %, or from 0.01 weight % to 0.75 weight %, or from 0.01 to 0.70 weight %, or from 0.01 to 0.60 weight %, or from 0.01 weight % to 0.50 weight % or from 0.10 weight % to 5 weight %, or from 0.10 weight % to 4 weight %, or from 0.10 weight % to 3 weight %, or from 0.10 weight % to 2.0 weight %, or from 0.10 weight % to 1.0 weight %, or from 0.10 weight % to 0.90 weight %, or from 0.10 weight % to 0.80 weight %, or from 0.10 weight % to 0.75 weight %, or from 0.10 weight % to 0.70 weight %, or from 0.10 weight % to 0.60 weight %, or from 0.10 weight % to 0.50 weight %, or from 0.25 weight % to 5 weight %, or from 0.25 weight % to 4 weight %, or from 0.25 weight % to 3 weight %, or from 0.25 weight % to 2.0 weight %, or from 0.25 weight % to 1.0 weight %, or from 0.25 weight % to 0.90 weight %, or from 0.25 weight % to 0.80 weight %, or from 0.25 weight % to 0.75 weight %, or from 0.25 weight % to 0.70 weight %, or from 0.25 weight % to 0.60 weight %, or from 0.25 weight % to 0.50 weight %, or from 0.50 weight % to 5 weight %, or from 0.50 weight % to 4 weight %, or from 0.50 weight % to 3 weight %, or from 0.50 weight % to 2.0 weight %, or from 0.50 weight % to 1.5 weight %, or from 0.50 weight % to 1.0 weight %, or from 0.50 weight % to 0.90 weight %, or from 0.50 weight % to 0.80 weight %, or from 0.50 weight % to 0.75 weight %, or from 0.80 weight % to 1.2 weight %, based on the total weight of the polymer composition equaling 100 weight %.

In certain aspects of the invention, the primary antioxidant can be present (total loading) in the polyester compositions of the invention in the amount of from 0.01 weight % to 5 weight % or from 0.01 weight % to 4 weight % or from 0.01 weight to 3 weight % or from 0.01 to 2.0 weight % or from 0.01 to 1.5 or from 0.01 to 1 weight % or from 0.01 to 0.75 weight % or from 0.01 to 0.50 weight % or from or from 0.10 weight % to 5 weight % or from 0.10 weight % to 4 weight % or from 0.10 weight to 3 weight % or from 0.10 to 2.0 weight % or from 0.10 to 1.5 or from 0.10 to 1 weight % or from 0.10 to 0.75 weight % or from 0.10 to 0.60 weight % or from, based on the total weight of the polymer composition equaling 100 weight %.

In certain aspects of the invention, the primary antioxidant can be present (total loading) in the polyester compositions of the invention in the amount of from 0.01 to 2.0 weight %, or from 0.10 to 2.0 weight %, from 0.01 to 1.0 weight %, or from 0.10 to 1.0 weight %, or from 0.10 to 1.5, or from 0.50 to 1.5, or from 0.75 to 1.25, or from 0.10 to 60 weight %, based on the total weight of the polyester composition equaling 100 weight %.

In one aspect of the invention, the primary antioxidant can be present (total loading) in the polyester compositions of the invention in the amount of from 0.01 to 1.0 weight %, 0.01 to 0.90 weight % or from 0.10 to 1.0 weight %, 0.10 to 0.90 weight % from 0.20 to 1.0 weight %, 0.20 to 0.90 weight % from 0.25 to 1.0 weight % or 0.25 to 0.90 weight %, based on the total weight of the polyester composition.

A “hindered amine” as used herein refers to a compound or polymer comprising a substituted piperidinyl group. In some embodiments, the substituted piperidinyl group may comprise 1, 2, 3, 4, 5, 6, 7, 8, or more substituents, such as, e.g., an alkyl, alkenyl, or alkoxy group. In some embodiments, the substituted piperidinyl group comprises 1 or 2 substituents (e.g., a C₁-C₂₀ alkyl or C₁-C₂₀ alkenyl group) at the 2- and/or 6-position of the piperidine ring. In some embodiments, the substituted piperidinyl group is a 2,2,6,6-tetraalkylpiperidinyl group (e.g., a 2,2,6,6-tetramethylpiperidinyl group).

In some embodiments, the substituted piperidinyl group comprises hydrogen, an alkyl group or an alkoxy group at the 1-position of the piperidine ring. In some embodiments, a hindered amine light stabilizer comprises an amine group that acts through and/or participates in a regenerative free radical scavenging mechanism.

One or more (e.g., 1, 2, 3, 4, 5, or more) substituted piperidinyl group(s) may be present in a hindered amine light stabilizer. In some embodiments, the hindered amine light stabilizer is a polymer and comprises one or more (e.g., 1, 2, 3, 4, 5, or more) substituted piperidinyl group(s) per repeating unit of the hindered amine light stabilizer. In some embodiments, an acrylic composition of the present invention may comprise a hindered amine light stabilizer that comprises one or more (e.g., 1, 2, 3, 4, or more) 2,2,6,6-tetraalkylpiperidinyl group(s) in the hindered amine light stabilizer. In some embodiments, the hindered amine light stabilizer may be a polymeric or oligomeric hindered amine light stabilizer, and may comprise one or more (e.g., 1, 2, 3, 4, or more) 2,2,6,6-tetraalkylpiperidinyl group(s) per repeating unit of the hindered amine light stabilizer.

Example hindered amine light stabilizers include, but are not limited to, those under the tradename Tinuvin® commercially available from BASF, such as, e.g., Tinuvin® PA 123, Tinuvin® 371, Tinuvin® 111 and/or Tinuvin® 622; those under the tradename Chimassorb® commercially available from BASF, such as, e.g., Chimassorb® 2020; and/or those under the tradename Cyasorb® commercially available from Cytec Industries, Inc., such as, e.g., Cyasorb® UV-3529.

### Secondary Antioxidant

The polyester composition of this invention contains at least one secondary antioxidant. The secondary antioxidant can be any that is known in the art. Molecular weight, reactivity and hydrolytic stability can be considered in the choice of secondary antioxidant. Some examples of secondary antioxidants are thiodipropionates, phosphites and metal salts. Thiopropionates are mostly used in polyolefins and are of limited use in condensation polymers. Phosphites are the most typically used in

thermoplastics. A typical phosphite antioxidant structure is shown below:

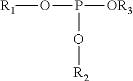

wherein R is selected from C₁ to C₂₀_alkyl groups.

Molecular weight, reactivity and hydrolytic stability must all be considered in the choice of secondary antioxidant. The secondary antioxidant can also be selected from an organophosphate or thioester, or a combination thereof. In a still further aspect, the secondary antioxidant comprises one or more compounds selected from tris(nonyl phenyl)phosphite [Weston™399, available from Addivant, Connecticut), tetrakis(2,4-di-tert-butylphenyl) [1,1-biphenyl]-4,4′-diylbisphosphonite, tris(2,4-di-tert-butylphenyl)phosphite (Irgafos™168, available from BASF), bis(2,4-di-tert-butylphenyl)pentaerythritol diphosphite, bis(2,4-dicumylphenyl)pentaerythritoldiphosphite, and distearyl pentaerythritol diphosphite.

In one embodiment, the polyester composition of the invention contains at least one phosphite comprising an aryl phosphite or an aryl monophosphite. As used herein, the term “aryl monophosphite” refers to a phosphite stabilizer which contains: (1) one phosphorus atom per molecule; and (2) at least one aryloxide (which may also be referred to as a phenoxide) radical which is bonded to the phosphorus. In one embodiment, the aryl monophosphite contains C1 to C20, or C1 to C10, or C2-C6 alkyl substituents on at least one of the aryloxide groups. Example of C1 to C20 alkyl substituents include but are not limited to methyl, ethyl, n-propyl, isopropyl, n-butyl, sec-butyl and iso-butyl, tertiary butyl, pentyl, hexyl, octyl, nonyl, and decyl. Preferred aryl groups include but are not limited to phenyl and naphthyl.

In one embodiment, the phosphites useful in the invention comprise tertiary butyl substituted aryl phosphites. In another embodiment, the aryl monophosphite comprises at least one of triphenyl phosphite, phenyl dialkyl phosphites, alkyl diphenyl phosphites, tri(nonylphenyl)phosphite, tris-(2,4-di-t-butylphenyl)phosphite, bis(2,4-di-t-butyl-6-methylphenyl)ethyl phosphite, (believed to be Irgafos™38, available from BASF), 2,2,2-nitrilo[triethyltris(3,3,5,5-tetra-tert-butyl-1,1-biphenyl-diyl)phosphite (believed to be Irgafos™12, available from BASF. In another embodiment, the aryl monophosphite is selected from one or more of tris-(2,4-di-t-butylphenyl)phosphite, bis(2,4-di-t-butyl-6-methylphenyl)ethyl phosphite, and 2,2,2-nitrilo[triethyltris(3,3,5,5-tetra-tert-butyl-1,1-biphenyl-diyl)phosphite. In a further embodiment, an aryl monophosphite useful in the invention is tris-(2,4-di-t-butylphenyl)phosphite.

In one embodiment, suitable secondary antioxidant additives include, for example, organic phosphites such as, tris(nonyl phenyl)phosphite, tris(2,4-di-t-butylphenyl)phosphite, bis(2,4-di-t-butylphenyl)pentaerythritol diphosphite, distearyl pentaerythritol diphosphite or the like; or combinations comprising at least one of the foregoing antioxidants.

In one aspect, the secondary antioxidant is present in the polyester composition in an amount from about 0.01 weight % to about 3.0 weight %, or from 0.01 weight % to 2 weight %, or from 0.01 weight % to 1 weight % or from 0.10 weight % to 5 weight %, or from 0.10 weight % to 4 weight %, or from 0.10 weight % to 3 weight %, or from 0.10 weight % to 2 weight %, or from 0.10 weight % to 1 weight %, or from 0.25 weight % to 1 weight %, or from 0.25 weight % to 0.75 weight %, based on the total weight of the polymer composition.

In a further aspect, the secondary antioxidant is present in the polyester composition in an amount from about 0.01 weight % to about 2.5 weight %. In still another aspect, the secondary antioxidant is present in an amount from about 0.5 weight % to about 2.5 weight %. In yet another aspect, the secondary antioxidant is present in an amount from about 0.5 weight % to about 2.0 weight % In still another aspect, the secondary antioxidant is present in an amount from about 0.05 weight % to about 0.75 weight %. In still another aspect, the secondary antioxidant is present in an amount from about 0.05 weight % to about 0.75 weight %. In certain embodiments, the secondary antioxidant is present in an amount from about 0.1 weight % to about 1.0 weight %, or about 0.2 weight % to about 0.8 weight %, or 0.25 to 0.75 weight %. In one embodiment, the secondary antioxidant is present in an amount from about 0.35 weight % to about 0.65 weight %.

In certain aspects of the invention, the weight ratio of primary antioxidant to secondary antioxidant present in the polyester compositions useful in the invention can be from 5:1 to 1:5. In certain aspects of the invention, the weight ratio of primary antioxidant to secondary antioxidant can be 5:1 or 4:1 or 3:1 or 2:1 or 1:1 or 1:2 or 1:3 or 1:4 or 1:5. In certain aspects of the invention, the weight ratio of primary to secondary antioxidant is 1:1 or 1:2 or 1:3 or 1:4 or 1:5. In certain aspects of the invention, the weight ratio of primary antioxidant to secondary antioxidant is 2:1 to 1:2, e.g., 2:1. In certain aspects of the invention, the weight ratio of primary antioxidant to secondary antioxidant is in the range from 1.1:1 to 4:1, or 1.2:1 to 4:1, or 1.5:1 to 4:1, or 1.6:1 to 4:1, or 1.8:1 to 4:1, or 2:1 to 4:1, or 1.1:1 to 3:1, or 1.2:1 to 3:1, or 1.5:1 to 3:1, or 1.6:1 to 3:1, or 1.8:1 to 3:1, or 2:1 to 3:1, 1.1:1 to 2.5:1, or 1.2:1 to 2.5:1, or 1.5:1 to 2.5:1, or 1.6:1 to 2.5:1, or 1.8:1 to 2.5:1, or 2:1 to 2.5:1.

The polyester compositions of the invention can comprise at least one chain extending agent. Suitable chain extending agents include, but are not limited to, multifunctional (including, but not limited to, bifunctional) isocyanates, multifunctional epoxides, including for example, and phenoxy resins. In one embodiment, the chain extending agents have epoxide dependent groups. In one embodiment, the chain extending additive can be one or more styrene-acrylate copolymers with epoxide functionalities. In one embodiment, the chain extending additive can be one or more copolymers of glycidyl methacrylate with styrene.

Chain extending additives include compounds such as bisanhydrides, bisoxaolines, and bisepoxides which react with —OH or —COH end groups caused by hydrolytic degradation. Chain extending additives can also be added during melt processing to build molecular weight through ‘reactive extrusion’ or ‘reactive chain coupling’. Another effective type of chain extending additive are styrene-acrylate copolymers with epoxide functionalities.

In certain embodiments, chain extending agents are added at the end of the polymerization process or after the polymerization process. If added after the polymerization process, chain extending agents can be incorporated by compounding or by addition during conversion processes such as injection molding or extrusion.

The amount of chain extending agent used can vary depending on the specific monomer composition used and the physical properties desired but is generally about 0.01 percent by weight to about 10 percent by weight, 0.1 percent by weight to about 10 percent by weight, from about 0.01 to about 5 percent by weight, from about 0.1 to about 5 percent by weight, from about 0.01 percent by weight to about 3 percent by weight, from about 0.1 to about 3 percent by weight, from about 0.01 percent by weight to about 2 percent by weight, from about 0.1 to about 2 percent by weight, from about 0.01 percent by weight to about 1 percent by weight, from about 0.1 to about 1 percent by weight, from about 0.01 percent by weight to about 0.5 percent by weight, and from about 0.1 to about 0.5 based on the total weight of the polyester.

Chain extending additives can also be added during melt processing to build molecular weight through ‘reactive extrusion’ or ‘reactive chain coupling or any other process known in the art.

Chain extending agents useful in the invention can include, but are not limited to, copolymers of glycidyl methacrylate (GMA) with alkenes, copolymers of GMA with alkenes and acrylic esters, copolymers of GMA with alkenes and vinyl acetate, copolymers of GMA and styrene. Suitable alkenes comprise ethylene, propylene, and mixtures of two or more of the foregoing. Suitable acrylic esters comprise alkyl acrylate monomers, including, but not limited to, methyl acrylate, ethyl acrylate, propyl acrylate, butyl acrylate, and combinations of the foregoing alkyl acrylate monomers. When present, the acrylic ester can be used in an amount of 15 weight % to 35 weight %, based on the total amount of monomer used in the copolymer, or in any other range described herein. When present, vinyl acetate can be used in an amount of 4 weight % to 10 weight % based on the total amount of monomer used in the copolymer.

In certain embodiments, the chain extending additive comprises acrylic esters comprising monomers selected from alkyl acrylate monomers, including, but not limited to, methyl acrylate, ethyl acrylate, propyl acrylate, butyl acrylate, and combinations thereof. In embodiments, the chain extending additive is a copolymer comprising at least one acrylic ester and styrene.

Illustrative examples of suitable chain extending agents comprise ethylene-glycidyl acrylate copolymers, ethylene-glycidyl methacrylate copolymers, ethylene-glycidyl methacrylate-vinyl acetate copolymers, ethylene-glycidyl methacrylate-alkyl acrylate copolymers, ethylene-glycidyl methacrylate-methyl acrylate copolymers, ethylene-glycidyl methacrylate-ethyl acrylate copolymers, and ethylene-glycidyl methacrylate-butyl acrylate copolymers.

Examples of useful chain extending agents include but are not limited to Joncryl 4368, Joncryl™4468 (copolymers of glycidyl methacrylate with styrene), Joncryl™4368, Joncryl™4470, Joncryl™4370, Joncryl™ 4400, Joncryl™4300, Joncryl™4480, Joncryl™4380, Joncryl™4485, Joncryl™4385, and mixtures thereof commercially available from BASF Corporation, New Jersey.

In one embodiment, the chain extending agents can be styrene-acrylate copolymers with glycidyl groups. In another embodiment, the chain extending agent can be a copolymer of glycidyl methacrylate and styrene.

In one embodiment, the polymeric chain extending agent can have an average of greater than or equal to 2 pendant epoxy groups per molecule, greater than or equal to 3 pendant epoxy groups per molecule; or an average of greater than or equal to 4 pendant epoxy groups per molecule; or an average of greater than or equal to 5 pendant epoxy groups per molecule; or an average of greater than or equal to 6 pendant epoxy groups per molecule; or an average of greater than or equal to 7 pendant epoxy groups per molecule; or more specifically, an average of greater than or equal to 8 pendant epoxy groups per molecule, or, more specifically, an average of greater than or equal to 11 pendant epoxy groups per molecule, or, more specifically, an average of greater than or equal to 15 pendant epoxy groups per molecule, or, more specifically, an average of greater than or equal to 17 pendant epoxy groups per molecule. The lower limits of the number of pendant epoxy groups may be determined by one of ordinary skill in the art to apply to specific manufacturing conditions and/or to particular end-use applications. In certain embodiments, the chain extending agent can have from 2 to 20 pendant epoxy groups per molecule, or from 5 to 20 pendant epoxy groups per molecule, or from 2 to 15 pendant epoxy groups per molecule, or from 2 to 10 pendant epoxy groups per molecule, or from 2 to 8 pendant epoxy groups per molecule, or 3 to 20 pendant epoxy groups per molecule, or from 3 to 15 pendant epoxy groups per molecule, or from 5 to 15 pendant epoxy groups per molecule, or from 3 to 10 pendant epoxy groups per molecule, or from 5 to 10 pendant epoxy groups per molecule, or from 3 to 8 pendant groups per molecule, or from 3 to 7 pendant epoxy groups per molecule.

In certain aspects of the invention, the chain extending agent can be present (total loading) in the polyester composition of the invention in the amount of from 0.01 weight % to 5 weight %, or from 0.01 weight % to 4 weight %, or from 0.01 weight % to 3 weight %, or from 0.01 weight % to 2, weight % or from 0.01 weight % to 1 weight %, or from 0.10 weight % to 5 weight %, or from 0.10 weight % to 4 weight %, or from 0.10 weight % to 3 weight %, or from 0.10 weight % to 2 weight %, or from 0.10 weight to 1.5 weight %, or from 0.10 weight % to 1 weight, or from 0.25 weight % to 5 weight %, or from 0.25 weight % to 4 weight %, or from 0.25 weight % to 3 weight %, or from 0.25 weight % to 2 weight %, or from 0.25 weight to 1.5 weight %, or from 0.25 weight % to 1 weight, or from 0.25 weight % to 0.75 weight %, or from 0.50 weight % to 5 weight %, or from 0.50 weight % to 4 weight %, or from 0.50 weight % to 3 weight %, or from 0.50 weight % to 2 weight %, or from 0.50 weight to 1.5 weight %, or from 0.50 weight to 1.2 weight %, or from 0.50 weight % to 1 weight, based on the total weight of the polymer composition equaling 100 weight %. In certain embodiments, the chain extending agent can be present (total loading) in the polymer composition of the invention in the amount of from 0.25 weight % to 0.75 weight %, or from 0.30 weight % to 0.70 weight %, or from 0.4 weight % to 0.6 weight %.

In certain aspects of the invention, the chain extending agent is present (total loading) in the polyester composition of the invention in the amount of from 0.01 weight % to 1.5 weight % or from 0.10 weight % to 1 weight % or from based on the total weight of the polyester composition.

The initial amount of the chain extending agent used and order of addition will depend upon the specific chain extending agent chosen and the specific amounts of polyester employed.

In one embodiment, the weight ratio of chain extending agent to primary antioxidant present in the polyester compositions useful in the invention can be from 5:1 to 1:5. In certain aspects of the invention, the weight ratio of chain extending agent to primary antioxidant can be 5:1 or 4:1 or 3:1 or 2:1 or 1:1 or 1:2 or 1:3 or 1:4 or 1:5. In certain aspects of the invention, the weight ratio of chain extending agent to primary antioxidant is 3:1 to 1:2, or 2.5-3:1. In certain aspects of the invention, the weight ratio of chain extending agent to primary antioxidant is 1:2 or 3:1.

In certain aspects of the invention, the weight ratio of chain extending agent to secondary antioxidant present in the polyester compositions useful in the invention can be from 5:1 to 1:5. In certain aspects of the invention, the weight ratio of chain extending agent to secondary antioxidant can be 5:1 or 4:1 or 3:1 or 2:1 or 1:1 or 1:2 or 1:3 or 1:4 or 1:5. In certain aspects of the invention, the weight ratio of chain extending agent to secondary antioxidant is 3:1. In certain aspects of the invention, the weight ratio of chain extending agent to secondary antioxidant is 1:1 or 1.5:1 or 1.3:1. In another embodiment, the weight ratio of chain extending agent to secondary antioxidant is 1:1 to 3:1, or 1:1 to 2:1.

In certain embodiments, the polyester composition comprises: (1) at least one hindered phenolic antioxidant that comprises one or more compounds selected from pentaerythritol tetrakis[3-(3,5-di-t-butyl-4-hydroxyphenyl)propionate, octadecyl-3-(3,5-di-t-butyl-4-hydroxyphenyl)-propionate, N,N′-hexane-1,6-diyl-bis[3-(3,5-ditert-butyl-4-hydroxyphenyl)propionamide, benzenepropanoic acid 3,5-bis(1,1-dimethylethyl)-4-hydroxyoctadecyl ester, and octadecyl-3-(3,5-di-tert.butyl-4-hydroxyphenyl)-propionate (CAS number 2082); (2) at least one phosphite that is chosen from tris-(2,4-di-t-butylphenyl)phosphite, bis(2,4-di-t-butyl-6-methylphenyl)ethyl phosphite, or 2,2,2-nitrilo[triethyltris(3,3,5,5-tetra-tert-butyl-1,1-biphenyl-diyl)phosphite; and (3) at least one chain extending agent that is a copolymer of glycidyl methacrylate and styrene.

In certain embodiments, the polyester composition comprises at least one hindered phenolic antioxidant that is pentaerythritol tetrakis[3-(3,5-di-t-butyl-4-hydroxyphenyl)propionate; at least one phosphite that is tris(2,4-di-tert-butylphenyl)phosphite; and at least one chain extending agent that is Joncryl™4468 additive.

In one embodiment of the present invention, a primary antioxidant is incorporated in the hindered phenol family, i.e., Irganox™ 1010 commercially available from BASF Corporation, New Jersey, in the amounts of 0.01 to about 2.0% by weight, a secondary antioxidant in the phosphite family, i.e, Irgafos™168 commercially available from BASF Corporation, New Jersey, in the amounts of 0.01 to 2.0% by weight, and a chain extending agent in the styrene-acrylate copolymer family, i.e., Joncryl™4468 commercially available from BASF Corporation, New Jersey, in the amounts from 0.01 to 2.0% by weight into a polyester or copolyester.

In one embodiment, the polyester composition comprises (1) at least one phenolic antioxidant in the amount of from 0.01 weight % to 2.0 weight %, (2) at least one phosphite in the amount of from 0.10 weight % to 1.0 weight %, and (3) said chain extending agent in the amount of from 0.25 weight % to 2.0 weight percent, based on the total weight of the polyester composition.

In one embodiment, the polyester composition comprises (1) at least one phenolic antioxidant in the amount of from 0.10 weight % to 1.5 weight %, or from 0.10 weight % to 1.0 weight %, or from 0.50 weight % to 1.5 weight %, or from 0.75 weight % to 1.25 weight %, (2) at least one phosphite in the amount of from 0.10 weight % to 1.0 weight %, or 0.10 weight % to 0.75 weight %, or from 0.25 weight % to 0.75 weight %, and (3) at least one chain extending agent in the amount of from 0.10 weight % to 1.0 weight %, or 0.25 weight % to 1.0 weight, or from 0.25 weight % to 0.75 weight % based on the weight of the polyester composition.

In one embodiment, the polyester composition comprises (1) at least one phenolic antioxidant in the amount of from 0.75 weight % to 1.25 weight %, (2) at least one phosphite in the amount of 0.10 weight % to 1.0 weight %, or from 0.25 weight % to 0.75 weight %, and (3) at least one chain extending agent in the amount of 0.10 weight % to 1.0 weight %, or from 0.25 weight % to 0.75 weight % based on the weight of the polyester composition.

In one embodiment, the polyester composition comprises a primary antioxidant in the hindered phenol family, preferably Irganox® 1010 commercially available from BASF, in the amounts of 0.01 to about 2.0% by weight, a secondary antioxidant in the phosphite family, preferably Irgafos® 168 commercially available from BASF, in the amounts of 0.01 to 0.5% by weight or Doverphos® 9228 in the amounts of 0.01 to 0.5%, and a chain extending agent in the styrene-acrylate copolymer family, preferably Joncryl® 4468 commercially available from BASF, in the amounts from 0.01 to 2.0% by weight wherein the % by weight is based on the weight of the polyester composition.

In one embodiment, the present invention can employ a primary antioxidant of the hindered phenol type, a secondary antioxidant in the phosphite family and a chain extending agent with epoxide functionalities.

The weight percentages specified herein can also be combined with the ratios of additives to each other that are specified. They can also be combined with the particular classifications of additives that are described herein. The weight ratios of one additive to another or weight percentages of additives are calculated based on the weight of the additive compared to the total weight of the polyester composition at the time of loading the additive into the composition (total loading) wherein all components equal 100 weight %.

In one embodiment of the invention, the polyester composition comprises at least one rigid polyester, at least one polyester elastomer, from about 0.1 to about 2% by weight of at least one hindered phenol primary antioxidant, from about 0.01 to about 0.5% by weight of at least one phosphite secondary antioxidant, and from about 0.01 to about 2.0% by weight of at least one styrene-acrylate copolymer; wherein the weight percent is based on the total weight of the polyester composition.

In one embodiment, the stabilizer compositions useful in the invention can improve or maintain color, reduce the loss of number average molecular weight, and/or inherent viscosity, and/or reduce the total number of carboxyl end groups, under the conditions as specified herein.

These combinations of primary antioxidant, secondary antioxidant, and chain extending agent useful in the present invention have been shown herein to be effective in the polyester composition. The improved thermal oxidative and hydrolytic stability can be measured by any method known in the art, for example, through using gel-permeation chromatography and through visual color observations, colorimeter, and/or spectrophotometry. Viscosity improvements can be measured by any method known in the art, for example, using parallel plate rheometry or inherent viscosity measures. Numbers of carboxyl end groups can be measured by titration.

In addition, the polyester compositions useful in this invention may also contain at least one other additive selected from colorants, dyes, mold release agents, flame retardants, plasticizers, nucleating agents, other stabilizers (including but not limited to, UV stabilizers, thermal stabilizers, hydrolytic stabilizers), fillers, and impact modifiers. In embodiments, the polymer compositions can contain from 0.01 to 25% by weight or 0.01 to 20% by weight or 0.01 to 15% by weight or 0.01 to 10% by weight or 0.01 to 5% by weight of the total weight of the polyester composition of common additives such as colorants, dyes, mold release agents, flame retardants, plasticizers, nucleating agents, stabilizers, including but not limited to, UV stabilizers, thermal stabilizers and/or reaction products thereof, fillers, and impact modifiers. Examples of typical commercially available impact modifiers well known in the art and useful in this invention include, but are not limited to, ethylene/propylene terpolymers; functionalized polyolefins, such as those containing methyl acrylate and/or glycidyl methacrylate; styrene-based block copolymer impact modifiers and various acrylic core/shell type impact modifiers. For example, UV additives can be incorporated into articles of manufacture through addition to the bulk, through application of a hard coat, or through coextrusion of a cap layer. Residues of such additives are also contemplated as part of the polymer composition.

Reinforcing materials may be useful in the polyester compositions of this invention. The reinforcing materials may include, but are not limited to, carbon filaments, silicates, mica, clay, talc, titanium dioxide, Wollastonite, glass flakes, glass beads and fibers, and polymeric fibers and combinations thereof. In one embodiment, the reinforcing materials are glass, such as, fibrous glass filaments, mixtures of glass and talc, glass and mica, and glass and polymeric fibers.

In certain embodiments, the polyester compositions of this invention can be blended with any other polymers known in the art. For example, the polyester compositions of the invention can comprise at least one polymer chosen from at least one of the following: poly(etherimides), polyphenylene oxides, poly(phenylene oxide)/polystyrene blends, polystyrene resins, polyphenylene sulfides, polyphenylene sulfide/sulfones, poly(ester-carbonates), polycarbonates, polysulfones, polysulfone ethers, and poly(ether-ketones).

In one embodiment, certain additional polymers other than the ones described in the polyester compositions of the invention, e.g., polycarbonate, can be present in an amount of 50 weight % or less, or 40 weight % or less, or 30 weight % or less, or 20 weight % or less, or 10 weight % or less, or 5 weight % or less; in another embodiment, 0.01 to 50 weight %, or 1 to 50 weight %, or 5 to 50 weight %, or 0.01 to 40 weight %, or 0.01 to 30 weight % or 0.01 to 20 weight %, or 0.01 to 10 weight % or 0.01 to 5 weight %.

In certain embodiments, the polyester compositions of the invention can comprise at least one other polymer. In embodiments, the at least one other polymer is selected from liquid crystalline polyesters/amides/imides, polyesteramides, polyimides, polyetherimides, polyurethanes, polyureas, polybenzimidazole, polybenzoxazoles, polyimines, polycarbonates, other polyesters, other copolyesters, and polyamides. In one embodiment, the polyester composition does not include polycarbonate. In one embodiment, the polyester composition does not include bisphenol polycarbonate. In one embodiment, the polyester composition does not include polybutylene terephthalate. In one embodiment, the polyester composition does not include polyarylene ethers. In one embodiment, the polyester composition does not include cellulose esters.

In certain embodiments for the polyester composition, the at least one other polymer is present in the composition in the amount of 50 weight % or less, or 40 weight % or less, or 30 weight % or less, or 20 weight % or less, or 10 weight % or less, or 5 weight % or less, based on the total weight of the polyester composition equaling 100 weight %. In embodiments, the at least one other polymer is present in the polyester composition in the amount of 0.01 to 50 weight %, or 1 to 50 weight %, or 5 to 50 weight %, or 0.01 to 40 weight %, or 0.01 to 30 weight % or 0.01 to 20 weight %, or 0.01 to 10 weight % or 0.01 to 5 weight %, based on the total weight of the polyester composition equaling 100 weight %.

In embodiments, the polyester compositions described herein do not contain carbon nanotubes.

An effective amount of the primary antioxidant, secondary antioxidant, and the chain extending additive can be determined by understanding fitness for use requirements, target properties and/or target criteria for various applications and/or thermoplastic processing conditions and/or when the chosen property is preserved during processing.

### Processes for Producing the Polyester Composition

The polyester composition of this invention can be produced by any method known in the art. To make the polyester composition, blends of the primary antioxidant, secondary antioxidant, chain extending agent, rigid polyester and polyester elastomer can either be prepared directly during the polymerization process or compounded to produce pellets using typical plastics compounding and extrusion techniques.

In one embodiment, a process to produce a polyester composition is provided comprising contacting a) at least one rigid polyester; b) at least one polyester elastomer; c) at least one primary antioxidant; d) at least one secondary antioxidant; and e) at least one chain extending additive to produce a polyester composition; wherein the polyester composition has a enthalpy of melting of 3 cal/gm or less.

The rigid polyester, the polyester elastomer, the primary antioxidant, the secondary antioxidant, and the chain extending additive additive can be melt compounded in either a twin screw compounding extruder, a single screw extruder, a Banbury™ type mixer or a Farrell Continuous Mixer™ to produce a homogenous blend. In one embodiment, the rigid polyester and the polyester elastomer melts at 240° C. or below, 230° C. or below, 220° C. or below, 210° C. or below, 200° C. or below, 190° C. or below or 180° C. or below.

In one embodiment, a process to produce a polyester composition is provided comprising extruding a) at least one rigid polyester; b) at least one polyester elastomer; c) at least one primary antioxidant; d) at least one secondary antioxidant; and e) at least one chain extending additive in an extrusion zone to produce a polyester composition; wherein the polyester composition has a enthalpy of melting of 3 cal/gm or less. The extrusion zone comprises at least one extruder. Examples were previously provided in this disclosure.

In another embodiment, a process to produce a polyester composition, is provided comprising 1) polymerizing at least one dicarboxylic acid and at least one diol; and b) at least one secondary antioxidant to produce a rigid polyester having a Tg greater than 60° C.; 2) polymerizing at least one dicarboxylic acid, at least one diol, and at least one polyol to produce a polyester elastomer having a Tg less than 0° C., and 3) contacting the rigid polyester with the polyester elastomer and at least one chain extending additive to produce the polyester composition; wherein the polyester composition has a enthalpy of melting of 3 cal/gm or less; wherein the polymerizing in steps 1) and/or 2) is conducted in the presence of at least one primary antioxidant; and wherein the polymerizing in steps 1) and/or 2) is conducted in the presence of at least one secondary antioxidant.

In another embodiment of the invention, a process to produce a polyester composition is provided comprising 1) polymerizing at least one dicarboxylic acid and at least one diol in the presence of a) at least one primary antioxidant; and b) at least one secondary antioxidant to produce a rigid polyester having a Tg greater than 60° C.; 2) polymerizing at least one dicarboxylic acid, at least one diol, and at least one polyol to produce a polyester elastomer having a Tg less than 0° C., and 3) contacting the rigid polyester with the polyester elastomer and at least one chain extending additive to produce the polyester composition; wherein the polyester composition has a enthalpy of melting of 3 cal/gm or less.

In another embodiment of the invention, a process to produce a polyester composition is provided comprising 1) polymerizing at least one dicarboxylic acid and at least one diol to produce a rigid polyester having a Tg greater than 60° C.; 2) polymerizing at least one dicarboxylic acid, at least one diol, and at least one polyol in the presence of a) at least one primary antioxidant; and b) at least one secondary antioxidant to produce a polyester elastomer having a Tg less than 0° C., and 3) contacting the rigid polyester with the polyester elastomer and at least one chain extending additive to produce the polyester composition; wherein the polyester composition has a enthalpy of melting of 3 cal/gm or less.

The types of rigid polyesters, polyester elastomer, primary antioxidant, secondary antioxidant, and chain extending additive as well as the amounts used were previously described in this disclosure.

The polyesters and copolyesters of the present invention are readily prepared by methods well known in the art, for example, as described in U.S. Pat. No. 2,012,267, incorporated herein by reference in its entirety. More particularly, the reactions for preparing the polyesters are usually carried out at temperatures of about 150° C. to about 300° C. in the presence of polycondensation catalysts such as titanium tetrachloride, manganese diacetate, antimony oxide, dibutyl tin diacetate, zinc chloride, or combinations thereof. The catalysts are typically employed in amounts of 10 to 1000 ppm, based on total weight of the reactants.

In any of the embodiments, the primary antioxidant can be in the form of a masterbatch concentrate; wherein the masterbatch concentrate comprises at least one rigid polyester, the primary antioxidant, and optionally the secondary antioxidant.

In any of the embodiments, the secondary antioxidant can be in the form of a masterbatch concentrate; wherein the masterbatch concentrate comprises at least one rigid polyester, the secondary antioxidant, and optionally, the primary antioxidant.

In any of the embodiments, the primary antioxidant can in the form of a masterbatch concentrate; wherein the masterbatch concentrate comprises at least one polyester elastomer, the primary antioxidant, and optionally, the secondary antioxidant.

In any of the embodiments, the secondary antioxidant is in the form of a masterbatch concentrate; wherein the masterbatch concentrate comprises at least one polyester elastomer, the secondary antioxidant, and optionally, the primary antioxidant.

The amount of primary antioxidant and/or secondary antioxidant in a masterbatch concentrate is that which is sufficient to supply the level of antioxidant as previously described in this disclosure.

### End Uses for Inventive Polyester Composition

An article is provided comprising a polyester composition; wherein the polyester composition comprises a) at least one rigid polyester; b) at least one polyester elastomer; c) at least one primary antioxidant; d) at least one secondary antioxidant; and e) at least one chain extending additive; wherein the composition has a enthalpy of melting of 3 cal/gm or less.

These fully compounded or prepared pellets can be processed using convention polymer processing methods, or concentrates of the above additives can be prepared and diluted with neat polyesters and copolyesters, to make sheet, film, injection molded articles, and blow molded articles, using conventional thermoplastic processing methods. To make powders that are useful for 3D printing applications or powder coating of metals, the compounded pellets can be subsequently ground and reduced in size at cryogenic temperatures. In another embodiment, the invention further relates to articles of manufacture comprising any of the polyester compositions described above.

The polyester compositions of this invention can have usefulness in multiple applications. The polyester of the present invention is suitable for use in low shear polymer melt processes such as rotational molding, powder slush molding, powder coating and 3D printing processes.

Areas that could benefit are applications that are at high temperatures and humidity levels for extended periods of time. These could include applications in the 3D printing of thermoplastic powders, additive printing and/or additive manufacturing, powder coating of metal articles, LED lighting, filtration media, electrical and electronic, under the hood automotive applications, maritime, aerospace, thermoplastic powder coatings and the chemical process industries, surgical simulation devices, and orthotic and prosthetic devices. In certain embodiments, the article of manufacture can comprise at least one light emitting diode (LED) assembly housing, or reflector. In embodiments, the article of manufacture comprises at least one 3D powder or material used to make a different article of manufacture. In embodiments, the article of manufacture is a molded or extruded article.

In embodiments, the article of manufacture is a fiber or a filament.

In embodiments, the article of manufacture is a film or sheet

Lower shear melt viscosities are very useful for 3-D printing applications where fast polymer flow from the rapid heat up of the polymer from a laser or infrared heat source is helpful to ensuring a well-formed and fused article.

In 3D printing, several processing methods are used which include High Speed Sintering (HSS) and Selective Laser Sintering (SLS). In the case of the HSS process, powdered polyester compositions are heated using an infrared (IR) heat lamp to create useful objects or in the SLS process, a CO2 laser is used to heat the powders. To speed up the printing process, the powders are often held at very high temperatures just below their melting point for up to 24 hours to minimize the heat output from the IR lamp. Polymers held at these high temperatures and times can undergo thermal oxidative degradation and hydrolytic degradation, if they are a condensation polymer. This can cause the molecular weight to drop and the polymer to discolor and render it unrecyclable and un-processable.

Furthermore, in processes such as 3-D printing from powders and traditional powder coating of metals, the ability to flow and create a homogenous article with no other force than gravity or surface tension is helpful in creating useful and aesthetically pleasing articles.

The use of light emitting diodes (LED) has become increasingly common in lighting applications in recent years. LEDs benefit from high efficiency compared to traditional light sources and can be designed to operate for extremely long periods of time. As such, LEDs require materials of construction that can also survive for long periods of time without degrading or losing their efficacy in these applications. Compounded plastic materials are used as reflector materials in the construction of LEDs both to provide control over the direction of emitted light as well as to protect the actual diode from damage. These compounded plastic materials can be thermoplastic or thermoset based on the needs of the LED in the application. For example, high power LEDs, with energy input requires >1.0 watts typically use thermoset materials due to the heat generated in use. Lower wattage LEDs can use thermoplastic materials that can be injection molded. These injection molded materials are cheaper to process and can include a range of conventional materials. During the assembly of LEDs, the diode is soldered to the LEAD frame and this soldering process requires that the thermoplastic materials are dimensionally stable during the soldering process. This requires that material to be semi-crystalline with a crystalline melting point in excess of 280° C. Additionally, since these molded thermoplastic parts reflect the LED light from the diode, they can provide high reflectivity during the lifetime of the application. Low color and high color stability, measured via color measurements as described herein, before and after aging, is often used as a proxy for reflectivity. In certain embodiments, these parts also have high mechanical properties because they protect the diode from damage and survive various processing steps without breaking. The properties of reflectivity and high mechanical strength can be improved by compounding various base resin with other additives. These additives can provide enhanced “whiteness” as is the case for titanium dioxide and they can provide high toughness as is the case for inorganic fillers like glass fiber. Stabilizers and nucleating agents can also be added to improve stability and increase the rate of crystallization respectively. Due to the high demands of the thermoplastic materials in these applications, PCT is currently used in large amounts for the thermoplastic LED applications. PCT has a crystalline melting point of 285° C. and is manufactured carefully to produce a material with very low color (high reflectivity). PCT can be compounded with titanium dioxide and glass fiber along with various stabilizers and additives to optimize the performance of this material in these applications. US Patent Application 2007/0213458 discloses the use of PCT compounds in Light-Emitting Diode Assembly Housings.

During the manufacture of injection molded articles, the thermoplastic resin undergoes thermal and shear induced degradation. Additionally, waste material that is not converted into usable parts should be recycled to reduce to overall cost of the material. For these reasons, the compounded thermoplastic material much be stable to processing without significant loss of the original performance. Additionally, the molded parts should maintain high reflectivity and high mechanical strength throughout the lifetime of the application, which in the case of LEDs, could be as long as 20+ years. This invention describes an optimized combination of additives that improves the process robustness of the compounded PCT resins. Improvements in reflectivity are measured via color and color stability using the color measurement as described herein. Reprocessability is measured via inherent viscosity (IV) before and after an extrusion or processing step.

In another embodiment, the invention further relates to articles of manufacture comprising any of the polyester compositions described above.

The methods of forming the polyester compositions into articles of manufacture, fibers, films, molded articles, containers, and sheeting are well known in the art. The polyester compositions are useful in articles of manufacture including, but not limited to, fibers, filaments, films, sheets, containers, extruded, calendered, and/or molded articles including, but not limited to, injection molded articles, extruded articles, cast extrusion articles, profile extrusion articles, melt spun articles, thermoformed articles, extrusion molded articles, injection blow molded articles, injection stretch blow molded articles, extrusion blow molded articles and extrusion stretch blow molded articles. The polyester compositions useful in the invention may be used in various types of film and/or sheet, including but not limited to extruded film(s) and/or sheet(s), calendered film(s) and/or sheet(s), compression molded film(s) and/or sheet(s), solution casted film(s) and/or sheet(s). Methods of making film and/or sheet include but are not limited to extrusion, calendering, compression molding, and solution casting. The polymer compositions and/or polymer blend compositions can be useful in forming fibers, films, light diffusing articles, light diffusing sheets, light reflecting articles, light reflecting sheets, light emitting diodes, 3D powders or other materials, 3D articles containing powders or other materials. The extruded sheet can be further modified using typical fabrication techniques such as thermoforming, cold bending, hot bending, adhesive bonding, cutting, drilling, laser cutting, etc. to create shapes useful for application as light reflectors and/or light diffusers.

In one embodiment, the light reflector article comprising the polymer compositions of the invention can comprise at least one inorganic light reflecting additive, for example, titanium dioxide, barium sulfate, calcium carbonate or mixtures thereof.

Other end-use applications that can employ the polyester compositions of the invention include but are not limited to: (1) membrane backing. It can be a film or a woven or nonwoven (wetlaid or melt blown/melt spun) mat. Improved temperature, chemical resistance, and/or hydrolytic resistance would be relevant to it as well; (2) spun-laid nonwoven webs using processes well known in the art such as meltblowing and spun bond processes, wherein the continuous PCT fiber is spun from a pellet and laid into a nonwoven fabric in a single processing step; dry-laid or wet-laid nonwoven webs using processes well known in the art such as carding or air-laid processes, wherein PCT fiber is first spun in one process, chopped into staple fiber and laid into nonwoven fabric in a secondary step, using dry-laying technologies; Such nonwoven webs can be useful for air and liquid filtration media, particularly those filtration applications which are routinely exposed to high temperatures (80-200 C) or corrosive chemicals. Wet laid webs is a common method for producing filtration media.

Machine clothing comprising monofilament, multifilament fibers, films or sheet, with improved thermal stability over existing PCT, PCT copolymers and additive formulations, to enable use in high temperature manufacturing environments, including for example belts used in the dryer section of paper and tissue making processes. Dry-laid media can include high temperature and/or chemically resistant bag house filters and variation thereof used to capture pollutants, such as those in in coal burning power plants, and various manufacturing processes.

Certain embodiments would include using the polyester compositions of the invention in film application. Film substrates with enhanced stability to high temperature processes and use conditions. High temperature processes may include variations of lead free soldering processes on films requiring good registration, flexibility, and/or optical clarity, as standalone or part of a multilayer system that may include inks, coatings, and/or other functionality.

As used herein, the abbreviation “wt” means “weight”. The inherent viscosity of the polymers, for example, the polyesters was determined in 60/40 (wt/wt) phenol/tetrachloroethane at a concentration of 0.5 g/100 ml at 25° C.

The following examples further illustrate how the compositions of matter of the invention can be made and evaluated, and are intended to be purely exemplary of the invention and are not intended to limit the scope thereof. Unless indicated otherwise, parts are parts by weight, temperature is in degrees C. or is at room temperature, loading level is measured in units of weight percentage based on the total weight of the initial polymer composition equaling 100 weight %; and pressure is at or near atmospheric.

It can be clearly seen from a comparison of the data in the above relevant working examples that the combination of the primary antioxidants, secondary antioxidants and chain extending agents useful in the invention within a certain loading level can improved oxidative stability, color and flow of the certain polymers.

The invention has been described in detail with reference to the embodiments disclosed herein, but it will be understood that variations and modifications can be affected within the scope of this invention.

The present invention could have usefulness in multiple applications. Areas that could benefit are applications that are at high temperatures and humidity levels for extended periods of time. These could include applications in the 3D printing of thermoplastic powders, powder coating of metal articles, LED lighting, electrical and electronic, under the hood automotive applications, maritime, aerospace, thermoplastic powder coatings and the chemical process industries, surgical simulation devices, and orthotic and prosthetic devices.

### Process of Making Articles Comprising the Polyester Composition

In one embodiment of the invention, a process of making a polyester coated article is provided, the process comprising coating an article with a polyester composition to produce the polyester coated article; wherein the wherein the polyester composition comprises a) at least one rigid polyester; b) at least one polyester elastomer; c) at least one primary antioxidant; d) at least one secondary antioxidant; and e) at least one chain extending additive; wherein the composition has a enthalpy of melting of 3 cal/gm or less.

In another embodiment of the invention, a process to coat a surface is provided comprising:
a. providing the polyester composition in powdered form to produce a powdered polyester composition;
b. spreading the powdered solid polyester composition onto a surface;
c. heating the powdered polyester composition to form a molten polyester coating; and
d. cooling the molten polyester coating to form a solid polyester coating.

In another embodiment, a process to coat a metal article is provided comprising: a. providing the polyester composition in powdered form to produce a powdered polyester composition; b. Spreading the powdered solid polyester composition onto a metal surface; c. Heating the powdered polyester composition on the metal surface to form a molten polyester coating; and d. Cooling the molten polyester coating on the metal surface to form a solid polyester coating on the metal surface. The metal surface can be any type of appliance, such as, dishwasher racks.

In another embodiment of the invention, a process of manufacturing a molded article is provided, the process comprising:
1. placing a polyester composition in a mold having mold surfaces; wherein the polyester composition comprises a) at least one rigid polyester; b) at least one polyester elastomer; c) at least one primary antioxidant; d) at least one secondary antioxidant; and e) at least one chain extending additive; wherein the composition has a enthalpy of melting of 3 cal/gm or less;
2. heating the polyester composition until it becomes molten;
3. dispersing the molten polyester composition to cover the mold surfaces;
4. solidifying the molten polyester to form a solid molded article; and
5. removing the molded article from the mold.

### EXAMPLES

Samples for all testing were compounded on a Coperion 25 mm twin screw compounding extruder to make pellets. Screw RPM was set at 200, and Zone 1 was set at 180° C. Zones 2 to 11 were set at 250° C., and the die was set at 250° C. The barrel temperatures had to be increased to 280° C. for samples 8 and 9 because the pellets would not melt. Extrudate exited a two-hole die into a water bath to be cooled then into a pelletizer. These pellets were then injection molded into 4″×4″×0.125″ plaques and 0.125″ tensile and flexural bars on a BOY 22 injection molding machine. Barrel temperature was set at 240° C., mold at 70° C., injection pressure was set at 80 bar, cooling was set for 25 seconds, and ejection force was set at 125 bar.

Samples for powder coating were prepared by cryogenically grinding pellets of each formulation in an attrition mill with liquid nitrogen until a particle size of approximately 100 to 150 microns was achieved. This powdered material was then spray coated using an electrostatic coating applicator to cold rolled steel panels. The panels were then heated above the melting point of each formulation to form a film on each panel.

### Hot Stage Microscope Method:

The hot stage microscope method is a method developed to monitor the visual changes in a material with a microscope as the material is subjected to increased temperatures. The system was designed around an existing stereo microscope, the Nikon SMZ1000. A Point Grey Research Flea3 color camera was used to capture images from the microscope's objective. The camera has a 1/1.8 inch CCD sensor with 1928×1448 pixel resolution with a 3.69 μm pixel size. A 1″ CCD C-mount adapter from SPOT Imaging Solutions was used to combine the camera with the microscope. A Linkam DSC 600 hot stage system was used for controlling heating and cooling cycles during experiments. Additionally, a fiber optic halogen lamp system was used for sample illumination. No sample prep was needed, samples were placed as received in 5 mm aluminum DSC pans. Software to integrate the digital camera and hot stage systems was written using National Instruments (NI) Labview 2018. Using ActiveX drivers provided by Linkam, the hot stage manufacturer, it was possible to send and receive serial commands to and from the hot stage apparatus. This, coupled with NI Imaqdx drivers, allowed for the creation of images with temperature and time information displayed as an overlay.

### ASTM D2240 Durometer Hardness—Experimental

### Test Method:

A Durometer Type D Hardness method was used on testing instrument Rex Durometer Model OS-1 Stand. The method allows sample to be indented by an indenter on the tip of the instrument, and the load is recorded.

Sample dimension: The standard ASTM D 2240 type specimen shall be a minimum of 6.0 mm thick

### Relative Humidity:

The samples were conditioned in the PCL (Lab 118) at a temperature of 73±2° F. and relative humidity of 50±5% for 40 hours according to ASTM D-618 “Standard Practice for Conditioning Plastics for Testing”.

### Instrumentation:

he Rex Durometer Model OS-1 Stand Type D was used.

### ASTM D256 Notched IZOD & ASTM D4812 Unnotched IZOD

### Notched & Unnotched IZOD Test:

The test specimen is cut from either a molded flex or tensile bar, and loaded into the cantilever beam for impact. For notched IZOD, the bar is held in place such that the energy will be focused on the vertex of the notch. A calibrated hammer is released to swing and impact the mounted specimen, and the energy required to cause the “break” is recorded along with the “break type”—Non-break, Partial, Hinged, and Complete.

### Test Method:

All samples were prepared and tested in accordance with ASTM D256 A & ASTM D4812. The sample consisted of a flex or tensile bar cut to a standard 2.50+/−0.08 in×0.500+/−0.008 in, with a width between 0.118-0.500 in (typically 0.125 in), and if notched IZOD is requested “notched” to a depth of 10.16+/−0.05 mm in the center of the bar. This was verified using a calibrated Mitutoyo micrometer. The notch angle is 22.5°+/−0.5° on either side of the vertex, and the radius of the notch is cut to 0.25R+/−0.05.

### Relative Humidity:

The samples were conditioned in the PCL Lab 136 at a temperature of 73±2° F. and relative humidity of 50±5% for 40 hours according to ASTM D-618 “Standard Practice for Conditioning Plastics for Testing”.

### Instrumentation:

Testing Machines Incorporated (TMI) Cantilever beam IZOD impact instrument, using custom software to acquire data. At least five specimens were tested for each sample to obtain both the “break type” average as well as a total average.

### Definitions

Non-break—A break that presents with greater than 10% of the specimen width remaining at the break.

Partial—A break that presents with less than 10% of the specimen width remaining at the break, and able to support itself above a 90° axis.

Hinged—A break that presents with less than 10% of the specimen width remaining at the break, and unable to support itself above a 90° axis.

Complete—A break that presents as two pieces completely separated.

### ASTM D790 Flex Modulus

### Test Method:

A Flex method was used on testing instrument, Instron frame using Bluehill 3 and TestMaster 2 Software. The method allows sample to be bent at the center of the span, at a constant rate, and the load is recorded as the dependent variable.

Sample dimension: The standard ASTM D 790 type specimen shall be 3.175 mm (⅛ in.) thick, 12.7 mm (0.5 in.) wide, and 130 mm (5 in.) long

### Relative Humidity:

The samples were conditioned at a temperature of 73±2° F. and relative humidity of 50±5% for 40 hours according to ASTM D-618 “Standard Practice for Conditioning Plastics for Testing”.

### Instrumentation:

The Instron frame used Bluehill 3 and TestMaster 2 Software. Five specimens were tested for each sample to obtain an average value. The samples were tested at a span length of 2 inches with a speed of 0.05 inches/minute. Each sample was flexed to 5.5% strain.

### Glass Transition Temperature Data

Glass transition temperatures were measured using ASTM D3418-15. Samples were heated from 0 C ° to 280 C ° at 20 C ° per minute, cooled to 0 C ° then heated again from 0 C ° to 280 C ° at 20 C ° per minute. The glass transition temperature and Heat of Fusion were determined from the second heat.

### Powder Application and Processing:

All samples were pulverized using a Retsch ZM-1 Centrifugal Mill. The following variables can be changed to modify the rate and intensity of the size reduction:
RPM—10,000 or 20,000
Rotor—6 or 12 teeth
Ring Sieves—Available in a variety of opening sizes

For the first test, sample #1 was chilled to −40° C. and introduced to the grinding mill with the 6-tooth rotor at 20K RPM and a 1.0 mm screen. The resulting powder was very coarse.

Next, sample 1 was combined with liquid nitrogen in a stainless steel beaker and the chilled material was fed into the grinder under the same conditions as the first test. The material was easier to pulverize but was still too coarse for electrostatic spray.

The ring sieve was swapped to one with 0.75 mm openings and the process was repeated. The pulverized material was passed through an 80 mesh (180 μm) screen and the fine powder was used to spray test panels. This process was repeated for the remainder of the thermoplastic samples.

### Electrostatic Application and Bake:

The powder was sprayed on bare cold rolled steel (QD-46) and Bonderite 1000 pre-treated cold rolled steel (R-46-1) test panels using a Nordson Encore electrostatic spray gun. The powder applied readily to the substrate. The panels were placed in an electric convection oven at 230° C. for 15 minutes (substrate temperature). Most of the materials melted and flowed well under that condition. Compositions 4, 7, and 9 did not appear to fully melt at 230° C. and were reintroduced to the oven for 10 minutes at 250° C.

Adhesion was evaluated per the ASTM 3359 crosshatch adhesion and tape pull test.

Impact resistance was measured using a Gardner impact tester using ASTM D2794.

### Salt Fog

The coated metal panels were scribed with an “X” were exposed in a Q-Fog salt fog spray tester at 35 C and tested per ASTM B1117 and removed periodically and visually inspected for appearance, blister size and blister frequency per ASTM D714, face rust per ASTM D610 and scribe rust per ASTM D1654.

### Tensile Properties

Samples were injection molded to a thickness of 3 mm into large tensile bars (Type 1) and tested per ASTM D638.

### Color, Light Transmission and Haze

Samples of each composition were injection molded into 4″×4″×3 mm plaques and measured for light transmission and haze per ASTM D 1003 and color difference per ASTM D2244.

### Discussion of Results and Observations:

We have unexpectedly discovered that blends of rigid and flexible copolyesters incorporating an antioxidant package, can be suitable for applications requiring polymers in a powdered form that are processed at high temperatures and low shear.

Critical attributes for a powder coated article can include good adhesion to a substrate, good impact resistance, good corrosion resistance, low temperature processing, good thermal stability, and good low shear flow properties. Good adhesion is important in many cases and applications so the coating will not flake or chip off the substrate. This can also be related to good impact and corrosion resistance because if interfacial adhesion is compromised, corrosive liquids could infiltrate under the coating and cause corrosion and cause low impact strength and brittle failures during impact by not conforming and deforming. Low temperature processing is important for saving energy during processing and decreasing cycle times. Good thermal stability is important as materials could be at elevated temperatures close to their melting point for multiple hours or at highly elevated temperatures to allow them to flow and coalesce from a powder to “liquid” state to form a continuous film. This can be accomplished by incorporating a robust antioxidant system to prevent thermal oxidative degradation and decrease of molecular weight.

The present invention solves many of these problems and can be illustrated by the following examples. Table 2 contains data which supports the below observations.

An antioxidant system is incorporated into examples 2, 3, 4, 5, 6, 7, 8, 9, 10, 11. The importance of this will be shown in the other tests.

Good melt or flow at is illustrated in examples 1, 2, 3, 6, 7, 9, 10, 11 as they melt and flow at 240 C or less in the hot stage melt test. This shows these compositions can melt, flow, and coalesce at a reasonably low thermoplastic processing temperature. Examples 4 and 5 did not flow well at 240 C or less but test panels were still coated and prepared. It should be noted that example 8 could not be processed at all and no test panels could be prepared with this composition.

Good corrosion resistance after 500 hours of Salt Fog testing is illustrated by examples (1, 2, 3, 6, 10, 11) exhibiting a blister size of 6 or greater and a scribe rust value of 6 or greater. This shows these materials have some degree of interfacial adhesion to the substrate.

Good impact resistance with an impact resistance of 160 ft-lbs measured using a falling dart test was illustrated by examples 2, 3, 5, 6, 10, 11. The importance of an antioxidant package is confirmed by example 1 having good corrosion resistance which indicates some degree of adhesion, but the lack of thermal stability caused the material to not adhere to the metal panel and fracture due to polymer degradation.

When combined with a heat of fusion criteria of 3 cal/gm or less, only examples 2, 3, 6, 10 and 11, which contain an antioxidant package, have the combination good low shear melt flow, good corrosion resistance, and good impact resistance. Good corrosion resistance and good impact resistance indicate good interfacial adhesion.

What is inventive is that the rigid portion of the composition is agnostic of polymer structure and chemistry; as long as the final attributes of good low shear melt flow, good corrosion resistance and good impact resistance are achieved, the composition can be characterized by a heat of fusion of 3 cal/gm or less. This is unexpected and inventive.

TABLE 1
Polyester Compositions

| | Comp. | | | | | | | | | | |
|---|---|---|---|---|---|---|---|---|---|---|---|
| | Ex. 1 | Ex. 2 | Ex. 3 | Ex. 4 | Ex.5 | Ex. 6 | Ex. 7 | Ex. 8 | Ex. 9 | Ex. 10 | Ex. 11 |
| Tritan ® TX2000 | 60 | 59 | 49 | | | | | | | | |
| Copolyester¹ | | | | | | | | | | | |
| Tritan ® TX1000 | | | | 49 | | | | | | | |
| Copolyester² | | | | | | | | | | | |
| Polyester 1³ | | | | | 49 | | | | | | |
| PETG (GN071)⁴ | | | | | | 49 | | | | | |
| PET (EN076)⁵ | | | | | | | 49 | | | | |
| PCT (13319)⁶ | | | | | | | | 49 | | | |
| Durastar ® | | | | | | | | | 49 | | |
| DS1010⁷ | | | | | | | | | | | |
| GMX200⁸ | | | | | | | | | | 49 | |
| DX4000⁹ | | | | | | | | | | | 49 |
| Ecdel ® 9966¹⁰ | 40 | 39 | 49 | 49 | 49 | 49 | 49 | 49 | 49 | 49 | 49 |
| Irganox ® 1010¹¹ | | 1 | 1 | 1 | 1 | 1 | 1 | 1 | 1 | 1 | 1 |
| Irgaphos ® 168¹² | | 0.5 | 0.5 | 0.5 | 0.5 | 0.5 | 0.5 | 0.5 | 0.5 | 0.5 | 0.5 |
| Joncryl ® 4468¹³ | | 0.5 | 0.5 | 0.5 | 0.5 | 0.5 | 0.5 | 0.5 | 0.5 | 0.5 | 0.5 |
| | 100 | 100 | 100 | 100 | 100 | 100 | 100 | 100 | 100 | 100 | 100 |

¹Tritan ® TX2000 amorphous polyester obtained from Eastman Chemical Company.
²Tritan ® TX1000 amorphous polyester obtained from Eastman Chemical Company.
³Polyester 1 polydimethylcyclohexanedicarboxylatecyclohexanedimethanol obtained from .
⁴PETG (GN071)—polyethylene terephthalate glycol copolyester GN071 obtained from Eastman Chemical Company.
⁵PET (EN076)—Eastar EN076 polyethylene terephthalate copolyester obtained from Eastman Chemical Company
⁶PCT (13319)—polycyclohexylenedimethylene terephthalate obtained from .
⁷Durastar ® DS1010—polycyclohexylenedimethylene terephthalate polyester obtained from Eastman Chemical Company.
⁸Eastman GMX200—amorphous copolyester obtained from Eastman Chemical Company.
⁹Tritan ® DX4000—amorphous copolyester obtained from Eastman Chemical Company.
¹⁰Ecdel ® 9966—copolyester elastomer obtained from Eastman Chemical Company.
¹¹Irganox ® 1010—sterically hindered phenolic primary antioxidant obtained from .
¹²Irgaphos ® 168—phosphite secondary antioxidant obtained from .
¹³Joncryl ® 4468—polymeric chain extending additive obtained from BASF

Testing of the above formulations can be found below. PGP-28′12

TABLE 2
PART 1

| | | | | Salt Fog Results - ASTM B117 | | | | |
|---|---|---|---|---|---|---|---|---|
| | Glycol Percents | | | | Blister | Blister | | |
| Formulation/ | Rigid portion | | | | Size - | Frequency - | Face Rust - | Scribe Rust - |
| Example | % CHDM | % TMCD | Formulation | Hours | ASTM D714 | ASTM D714 | ASTM D610 | ASTM D1654 |
| 1 | 65 | 35 | 60/40 TX2000/Ecdel | 0 | 8 | 9 | 10 | 10 |
| | | | | 250 | 8 | 9 | 8 | 7 |
| | | | | 500 | 7.67 | 8.67 | 7.67 | 6.33 |
| | | | | 750 | 7.67 | 8.67 | 6.67 | 6 |
| | | | | 1000 | 6.67 | 8 | 6 | 5.67 |
| 2 | 65 | 35 | 60/40 TX2000/Ecdel | 0 | 10 | 10 | 10 | 10 |
| | | | with AO | 250 | 9 | 8 | 9 | 7.67 |
| | | | | 500 | 9 | 8 | 9 | 6.67 |
| | | | | 750 | 9 | 8 | 9 | 6.67 |
| | | | | 1000 | 9 | 8 | 9 | 5.67 |
| 3 | 65 | 35 | 50/50 TX2000/Ecdel | 0 | 10 | 10 | 10 | 10 |
| | | | with AO | 250 | 9 | 6.33 | 7.67 | 8 |
| | | | | 500 | 8 | 6 | 7.67 | 6.67 |
| | | | | 750 | 7.67 | 6.67 | 7 | 5.67 |
| | | | | 1000 | 7 | 5.67 | 7 | 5.67 |
| 4 | 78 | 22 | 50/50 TX1000/Ecdel | 0 | 10 | 10 | 10 | 10 |
| | | | with AO | 250 | 6.67 | 5.67 | 8 | 8.67 |
| | | | | 500 | 5 | 4.67 | 5.67 | 7 |
| | | | | 750 | 4.5 | 4.5 | 5 | 6.5 |
| | | | | 1000 | 3.5 | 3.5 | 4 | 5.5 |
| 5 | 100 | 0 | 50/50 G16/Ecdel | 0 | 10 | 10 | 10 | 10 |
| | | | with AO | 250 | 9 | 2 | 2 | 8.33 |
| | | | | 500 | Stopped | Stopped | Stopped | Stopped |
| 6 | 69 | 0 | 50/50 GN071/Ecdel | 0 | 10 | 10 | 10 | 10 |
| | | | with AO | 250 | 9 | 5.33 | 6.33 | 7.33 |
| | | | | 500 | 7 | 4.33 | 5.33 | 6.33 |
| | | | | 750 | 7 | 5.5 | 5.5 | 6 |
| | | | | 1000 | 6 | 5 | 5 | 5 |
| 7 | 4.5 | 0 | 50/50 EN076/Ecdel | 0 | 10 | 10 | 10 | 10 |
| | | | with AO | 250 | 2 | 3.33 | 5 | 7.33 |
| | | | | 500 | 1 | 3 | 1.5 | 3.5 |
| | | | | 750 | Stopped | Stopped | Stopped | Stopped |
| 8 | 100 | 0 | 50/50 PCT/Ecdel | Did not run as material did not flow in Hot Stage Test | | | | |
| | | | with AO | | | | | |
| 9 | 100 | 0 | 50/50 DS1010/Ecdel | 0 | 10 | 10 | 10 | 10 |
| | | | with AO | 250 | 6.67 | 6 | 8 | 7 |
| | | | | 500 | 5 | 4 | 4 | 5.5 |
| | | | | 750 | Stopped | Stopped | Stopped | Stopped |
| 10 | 78 | 22 | 50/50 GMX200/Ecdel | 0 | 10 | 10 | 10 | 10 |
| | | | with AO | 250 | 9 | 3.33 | 6 | 7 |
| | | | | 500 | 9 | 2 | 4.33 | 6 |
| | | | | 750 | 9 | 2 | 4 | 6 |
| | | | | 1000 | 8 | 2 | 3 | 5.5 |
| 11 | 65 | 35 | 50/50 DX4000/Ecdel | 0 | 10 | 10 | 10 | 10 |
| | | | with AO | 250 | 9 | 4.67 | 8 | 7.33 |
| | | | | 500 | 9 | 3 | 6 | 6 |
| | | | | 750 | 9 | 2.67 | 5.5 | 5.33 |
| | | | | 1000 | 9 | 2.67 | 5.5 | 5.33 |

TABLE 2
PART 2

| | | | | Crosshatch | Impact Resistance ASTM D2794 | | |
|---|---|---|---|---|---|---|---|
| | Glycol Percents | | | adhesion | | | Bake |
| Formulation/ | Rigid portion | | | ASTM | Direct | Reverse | Temp |
| Example | % CHDM | % TMCD | Formulation | D3359 | (ft-lbs) | (ft-lbs) | (° C.) |
| 1 | 65 | 35 | 60/40 TX2000/Ecdel | 5B | <20 | <20 | 230 |
| 2 | 65 | 35 | 60/40 TX2000/Ecdel with AO | 5B | 160 | 160 | 230 |
| 3 | 65 | 35 | 50/50 TX2000/Ecdel with AO | 5B | 160 | 160 | 230 |
| 4 | 78 | 22 | 50/50 TX1000/Ecdel with AO | 5B | 20 | <20 | 250 |
| 5 | 100 | 0 | 50/50 G16/Ecdel with AO | 5B | 160 | 160 | 230 |
| 6 | 69 | 0 | 50/50 GN071/Ecdel with AO | 5B | 160 | 160 | 230 |
| 7 | 4.5 | 0 | 50/50 EN076/Ecdel with AO | 3B | 20 | <20 | 250 |
| 8 | 100 | 0 | 50/50 PCT/Ecdel with AO | | | | |
| 9 | 100 | 0 | 50/50 DS1010/Ecdel with AO | 5B | 40 | <30 | 250 |
| 10 | 78 | 22 | 50/50 GMX200/Ecdel with AO | 5B | 160 | 160 | 230 |
| 11 | 65 | 35 | 50/50 DX4000/Ecdel with AO | 5B | 160 | 160 | 250 |

TABLE 2
PART 3

| | | | | DSC - ASTM D3418 | | |
|---|---|---|---|---|---|---|
| | Glycol Percents | | | | | Heat of |
| Formulation/ | Rigid portion | | | Tg | Tm | Fusion |
| Example | % CHDM | % TMCD | Formulation | (° C.) | (° C.) | (cal/gm) |
| 1 | 65 | 35 | 60/40 TX2000/Ecdel | 62.7 | 195 | 0.955 |
| 2 | 65 | 35 | 60/40 TX2000/Ecdel | 78.2 | 199.5 | 1.476 |
| | | | with AO | | | |
| 3 | 65 | 35 | 50/50 TX2000/Ecdel | 75.6 | 197.3 | 2.24 |
| | | | with AO | | | |
| 4 | 78 | 22 | 50/50 TX1000/Ecdel | 88 | 201, 235 | 2.883 |
| | | | with AO | | | |
| 5 | 100 | 0 | 50/50 G16/Ecdel | 82.9 | 216 | 5.166 |
| | | | with AO | | | |
| 6 | 69 | 0 | 50/50 GN071/Ecdel | 76.5 | 201 | 2.207 |
| | | | with AO | | | |
| 7 | 4.5 | 0 | 50/50 EN076/Ecdel | 75.1 | 202, 237 | 5.426 |
| | | | with AO | | | |
| 8 | 100 | 0 | 50/50 PCT/Ecdel | 87.4 | 205, 275.7 | 5 |
| | | | with AO | | | |
| 9 | 100 | 0 | 50/50 DS1010/Ecdel | 76.7 | 202.8 | 4.803 |
| | | | with AO | | | |
| 10 | 78 | 22 | 50/50 GMX200/Ecdel | 75.3 | 192 | 1.955 |
| | | | with AO | | | |
| 11 | 65 | 35 | 50/50 DX4000/Ecdel | 112.8 | 187 | 1.563 |
| | | | with AO | | | |

| | | | Tensile Properties - ASTM D638 | | | | |
|---|---|---|---|---|---|---|---|
| | Izod - ASTM D256 | | Yeild | Break | % | % | Tensile |
| Formulation/ | Notched | Unotched | Strength | Strength | Strain | Strain | Modulus |
| Example | (J/m) | (J/m) | (MPa) | (MPa) | Yeild | Break | (MPa) |
| 1 | 1014 | 1817 | 37.1 | 39.5 | 4.5 | 242 | 1266 |
| 2 | 1015 | 1807 | 36.6 | 40.3 | 4.5 | 245 | 1244 |
| 3 | 1050 | 1494 | 29.9 | 32.9 | 4.7 | 282 | 992 |
| 4 | 1030 | 1259 | 24.5 | 30.6 | 6.6 | 275 | 753 |
| 5 | 1112 | 1204 | 21.7 | 25.6 | 5.8 | 282 | 612 |
| 6 | 546 | 1252 | 19.4 | 25.1 | 8.7 | 254 | 611 |
| 7 | 158 | 1308 | 21.8 | 28.7 | 9.7 | 482 | 696 |
| 8 | 79 | 1016 | 26.5 | 25.9 | 11.7 | 19 | 691 |
| 9 | 1006 | 1223 | 23.8 | 25.8 | 4.6 | 339 | 835 |
| 10 | 237 | 1302 | 22.1 | 29.7 | 11.4 | 222 | 647 |
| 11 | 1017 | 1218 | 23.6 | 31.8 | 9.6 | 217 | 719 |

TABLE 2
PART 4

| | | | | Flexural Properties - | | Shore | | | | | |
|---|---|---|---|---|---|---|---|---|---|---|---|
| | | | | ASTM D790 | | Hardness - | Color (ASTM D2244), Haze, Light | | | | |
| | Glycol Percents | | | Break | | ASTM | Transmittance (ASTM D1003) | | | | |
| Formulation/ | Rigid portion | | | Stress | Modulus | D2240 | | | | | % Light |
| Example | % CHDM | % TMCD | Formulation | (MPa) | (MPa) | D scale | L* | a* | b* | % Haze | Transmission |
| 1 | 65 | 35 | 60/40 TX2000/Ecdel | 51.2 | 1274 | 76 | 72.4 | 5.2 | 23.5 | 38.6 | 49.7 |
| 2 | 65 | 35 | 60/40 TX2000/Ecdel | 50.8 | 1255 | 78 | 69.8 | 5.7 | 21.8 | 48.4 | 21.8 |
| | | | with AO | | | | | | | | |
| 3 | 65 | 35 | 50/50 TX2000/Ecdel | 38.5 | 902 | 74 | 60.7 | 5.7 | 18.2 | 72.4 | 36.9 |
| | | | with AO | | | | | | | | |
| 4 | 78 | 22 | 50/50 TX1000/Ecdel | 32.7 | 750 | 72 | 47.3 | 1.45 | 15.6 | 100 | 22.7 |
| | | | with AO | | | | | | | | |
| 5 | 100 | 0 | 50/50 G16/Ecdel | 24.3 | 554 | 74 | 77.4 | 0.82 | 7.3 | 98 | 60 |
| | | | with AO | | | | | | | | |
| 6 | 69 | 0 | 50/50 GN071/Ecdel | 39.1 | 699 | 70 | 37.6 | 1.8 | 17.1 | 100 | 15.8 |
| | | | with AO | | | | | | | | |
| 7 | 4.5 | 0 | 50/50 EN076/Ecdel | 30.1 | 749 | 70 | 50.6 | 2.7 | 19.5 | 100 | 11.8 |
| | | | with AO | | | | | | | | |
| 8 | 100 | 0 | 50/50 PCT/Ecdel | 28.8 | 617 | 72 | 39.6 | 2.5 | 22.7 | 100 | 17.7 |
| | | | with AO | | | | | | | | |
| 9 | 100 | 0 | 50/50 DS1010/Ecdel | 36.4 | 894 | 71 | 40.4 | 1.4 | 13.9 | 100 | 17.7 |
| | | | with AO | | | | | | | | |
| 10 | 78 | 22 | 50/50 GMX200/Ecdel | 31.3 | 746 | 71 | 33.1 | 3.7 | 17.7 | 100 | 12.6 |
| | | | with AO | | | | | | | | |
| 11 | 65 | 35 | 50/50 DX4000/Ecdel | 28.8 | 689 | 73 | 46.57 | 2.9 | 20.9 | 100 | 22.4 |
| | | | with AO | | | | | | | | |

TABLE 3

| | Acids = 100% | | | |
|---|---|---|---|---|
| | Terephthalic | Isophthalic | Glycols = 100% | |
| Polymer | Acid | Acid | Cyclohexanedicarboxylate | Ethylene Glycol |
| TX2000 | 100 | | | |
| TX1000 | 100 | | | |
| Polyester 1 | | | 100 | |
| (PCCD) | | | | |
| GN071 | 100 | | | 69 |
| EN076 | 100 | | | 95.5 |
| PCT 13319 | 100 | | | |
| DS1010 | 65 | 35 | | |
| GMX200 | 100 | | | 78 |
| DX4000 | 100 | | | 65 |
| Ecdel | | | 100 | |

| | Glycols = 100% | | |
|---|---|---|---|
| | | | Polytetramethylene |
| Polymer | Cyclohexanedimethanol | Tetramethylcyclobutandiol | Glycol |
| TX2000 | 65 | 35 | |
| TX1000 | 78 | 22 | |
| Polyester 1 | 100 | | |
| (PCCD) | | | |
| GN071 | 31 | | |
| EN076 | 4.5 | | |
| PCT 13319 | 100 | | |
| DS1010 | 100 | | |
| GMX200 | | 22 | |
| DX4000 | | 35 | |
| Ecdel | 91.1 | | 8.9 |

TABLE 4
Part 1

| Formu- | Comp. Ex. 1 | | | | | Ex. 2 | | | | | Ex. 3 | | | | | Ex. 4 | | | | |
|---|---|---|---|---|---|---|---|---|---|---|---|---|---|---|---|---|---|---|---|---|
| lation | 60/40 TX2000/Ecdel | | | | | 60/40 TX2000/Ecdel with AO | | | | | 50/50 TX2000/Ecdel with AO | | | | | 50/50 TX1000/Ecdel with AO | | | | |
| Hours | 0 | 250 | 500 | 750 | 1000 | 0 | 250 | 500 | 750 | 1000 | 0 | 250 | 500 | 750 | 1000 | 0 | 250 | 500 | 750 | 1000 |
| Blister Size | 8 | 8 | 7.67 | 7.67 | 6.67 | 10 | 9 | 9 | 9 | 9 | 10 | 9 | 8 | 7.67 | 7 | 10 | 6.67 | 5 | 4.5 | 3.5 |
| Blister | 9 | 9 | 8.67 | 8.67 | 8 | 10 | 8 | 8 | 8 | 8 | 10 | 6.33 | 6 | 6.67 | 5.67 | 10 | 5.67 | 4.67 | 4.5 | 3.5 |
| Frequency | | | | | | | | | | | | | | | | | | | | |
| Face Rust | 10 | 8 | 7.67 | 6.67 | 6 | 10 | 9 | 9 | 9 | 9 | 10 | 7.67 | 7.67 | 7 | 7 | 10 | 8 | 5.67 | 5 | 4 |
| Scribe Rust | 10 | 7 | 6.33 | 6 | 5.67 | 10 | 7.67 | 6.67 | 6.67 | 5.67 | 10 | 8 | 6.67 | 5.67 | 5.67 | 10 | 8.67 | 7 | 6.5 | 5.5 |

TABLE 4
Part 2

| Formu- | Ex. 5 | | | | | Ex. 6 | | | | |
|---|---|---|---|---|---|---|---|---|---|---|
| lation | 50/50 Polyester 1/Ecdel with AO | | | | | 50/50 GN071/Ecdel with AO | | | | |
| Hours | 0 | 250 | 500 | 750 | 1000 | 0 | 250 | 500 | 750 | 1000 |
| Blister Size | 10 | 9 | Stopped | | | 10 | 9 | 7 | 7 | 6 |
| Blister | 10 | 2 | Stopped | | | 10 | 5.33 | 4.33 | 5.5 | 5 |
| Frequency | | | | | | | | | | |
| Face Rust | 10 | 2 | Stopped | | | 10 | 6.33 | 5.33 | 5.5 | 5 |
| Scribe Rust | 10 | 8.33 | Stopped | | | 10 | 7.33 | 6.33 | 6 | 5 |

| | | |
|---|---|---|
| Formu- | Ex. 7 | Ex. 8 |
| lation | 50/50 EN076/Ecdel with AO | 50/50 DS1010/Ecdel with AO |

| Hours | 0 | 250 | 500 | 750 | 1000 | 0 | 250 | 500 | 750 | 1000 |
|---|---|---|---|---|---|---|---|---|---|---|
| Blister Size | 10 | 2 | 1 | Stopped | | 10 | 6.67 | 5 | Stopped | |
| Blister | 10 | 3.33 | 3 | Stopped | | 10 | 6 | 4 | Stopped | |
| Frequency | | | | | | | | | | |
| Face Rust | 10 | 5 | 1.5 | Stopped | | 10 | 8 | 4 | Stopped | |
| Scribe Rust | 10 | 7.33 | 3.5 | Stopped | | 10 | 7 | 5.5 | Stopped | |

TABLE 4
Part 3

| Formu- | Ex. 9 | | | | | Ex. 10 | | | | |
|---|---|---|---|---|---|---|---|---|---|---|
| lation | 50/50 GMX200/Ecdel with AO | | | | | 50/50 DX4000/Ecdel with AO | | | | |
| Hours | 0 | 250 | 500 | 750 | 1000 | 0 | 250 | 500 | 750 | 1000 |
| Blister Size | 10 | 9 | 9 | 9 | 8 | 10 | 9 | 9 | 9 | 9 |
| Blister | 10 | 3.33 | 2 | 2 | 2 | 10 | 4.67 | 3 | 2.67 | 2.67 |
| Frequency | | | | | | | | | | |
| Face Rust | 10 | 6 | 4.33 | 4 | 3 | 10 | 8 | 6 | 5.5 | 5.5 |
| Scribe Rust | 10 | 7 | 6 | 6 | 5.5 | 10 | 7.33 | 6 | 5.33 | 5.33 |

1. A process of making a polyester coated article, said process comprising coating an article with a polyester composition to produce said polyester coated article; wherein said wherein said polyester composition comprises a) at least one rigid polyester; b) at least one polyester elastomer; c) at least one primary antioxidant; d) at least one secondary antioxidant; and e) at least one chain extending additive; wherein said composition has a enthalpy of melting of 3 cal/gm or less.

2. The process according to claim 1 wherein said coating comprises the following steps:
a. providing said polyester composition in powdered form to produce a powdered polyester composition;
b. spreading said powdered solid polyester composition onto a surface;
c. heating said powdered polyester composition to form a molten polyester coating; and
d. cooling said molten polyester coating to form a solid polyester coating.

3. The process according to claim 1 wherein said polyester composition melts at 240° C. or less.

4. The process according to claim 1 wherein after 500 hours of Salt Fog testing per ASTM B1117 said polyester composition exhibits a blister size of 6 or greater as determined by ASTM D714.

5. The process according to claim 4 wherein said polyester composition exhibits a scribe rust value of 6 or greater as determined by ASTM D1654.

6. The process according to claim 1 wherein said polyester composition has an impact resistance of 160 ft-lbs or greater as measured by ASTM D2794 when applied to metal panels.

7. The process according to claim 1 wherein said rigid polyester has a Tg of greater than 60° C.

8. The process according to claim 1 wherein said rigid polyester has a flexural modulus greater than 1,000 Mpa measured by ASTM D790.

9. The process according to claim 1 wherein said rigid polyester has an inherent viscosity as determined in 60/40 (wt/wt) phenol/tetrachloroethane at a concentration of 0.5 g/100 ml at 25° C. per ASTM D4603 ranging from 0.5 to 1 dL/g.

10. The process according to claim 1 wherein said polyester elastomer has a Tg of 50° C. or less.

11. The process according to claim 1 wherein said polyester elastomer has a flexural modulus of less than 1000 Mpa as measured by ASTM D790.

12. The process according to claim 1 wherein said polyester elastomer comprises at least one residue of an alicyclic diacid selected from the group consisting of hexahydrophthalic anhydride (HHPA), tetrahydrophthalic anhydride, tetrachlorophthalic anhydride, 5-norbornene-2,3-dicarboxylic anhydride, 5-norbornene-2,3-dicarboxylic acid, 2,3-norbornanedicarboxylic acid, 2,3-norbornanedicarboxylic acid anhydride, cyclohexane dicarboxylic acid (including the 1, 2-; 1,3-; and 1,4-isomers) (CHDA), dimethylcyclohexane (including the 1, 2-; 1,3-; and 1,4-isomers) (DMCD) and mixtures thereof.

13. The process according to claim 1 wherein said polyester elastomer comprises at least one residue of an acyclic aliphatic diacids selected from the group consisting of adipic acid, maleic anhydride, maleic acid, fumaric acid, itaconic anhydride, itaconic acid, citraconic anhydride, citraconic acid, dodecanedioic acid, succinic acid, succinic anhydride, glutaric acid, sebacic acid, azelaic acid, and mixtures thereof.

14. The process according to claim 1 wherein said polyester elastomer comprises at least one residue of di-alcohol components selected from the group consisting of to 2,2,4,4-tetraalkylcyclobutane-1,3-diol, 2,2-dimethyl-1,3-propanediol (neopentyl glycol), 1,2 cyclohexanedimethanol, 1,3-cyclohexanedimethanol, 1,4 cyclohexanedimethanol, 2,2,4-trimethyl-1,3-pentanediol, hydroxypivalyl hydroxypivalate, 2-methyl-1,3-propanediol, 2-butyl-2-ethyl-1,3-propanediol, 2-ethyl-2-isobutyl-1,3-propanediol, 1,3-butanediol, 1,4-butanediol, 1,5-pentanediol, 1,6-hexanediol, 2,2,4,4-tetramethyl-1,6-hexanediol, 1,10-decanediol, 1,4-benzenedimethanol, ethylene glycol, propylene glycol, diethylene glycol, dipropylene glycol, triethylene glycol, and tetraethylene glycol.

15. The process according to claim 1 wherein said polyester elastomer comprises residues of at least one polyol; wherein said polyol is selected from the group consisting of polytetramethylene ether glycol (PTMG), polyethylene glycol, polypropylene glycol, or any other polyether polyols and mixtures thereof.

16. The process according to claim 1 wherein said polyester elastomer comprises the residues of:
a. cyclohexane dicarboxylic acid (CHDA), and dimethylcyclohexane (DMCD);
b. cyclohexane dimethanol (CHDM),
c. polytetramethylene ether glycol (PTMG), and
d. trimelletic anhydride (TMA)

17. The process according to claim 1 wherein said primary antioxidant is at least one hindered phenol and/or at least one hindered amine.

18. The process according to claim 1 wherein said secondary antioxidant is selected from the group consisting of thiodipropionates, phosphites and metal salts.

19. The process according to claim 1 wherein said polyester composition comprises: (1) at least one hindered phenolic antioxidant that comprises one or more compounds selected from pentaerythritol tetrakis[3-(3,5-di-t-butyl-4-hydroxyphenyl)propionate, octadecyl-3-(3,5-di-t-butyl-4-hydroxyphenyl)-propionate, N,N′-hexane-1,6-diyl-bis[3-(3,5-ditert-butyl-4-hydroxyphenyl)propionamide, benzenepropanoic acid 3,5-bis(1,1-dimethylethyl)-4-hydroxyoctadecyl ester, and octadecyl-3-(3,5-di-tert.butyl-4-hydroxyphenyl)-propionate (CAS number 2082); (2) at least one phosphite that is chosen from tris-(2,4-di-t-butylphenyl)phosphite, bis(2,4-di-t-butyl-6-methylphenyl)ethyl phosphite, or 2,2,2-nitrilo[triethyltris(3,3,5,5-tetra-tert-butyl-1,1-biphenyl-diyl)phosphite; and (3) at least one chain extending agent that is a copolymer of glycidyl methacrylate and styrene.

20. The process according to claim 1 wherein said polyester composition comprises at least one rigid polyester, at least one polyester elastomer, from about 0.1 to about 2% by weight of at least one hindered phenol primary antioxidant, from about 0.01 to about 0.5% by weight of at least one phosphite secondary antioxidant, and from about 0.01 to about 2.0% by weight of at least one styrene-acrylate copolymer; wherein the weight percent is based on the total weight of the polyester composition.
